(19) United States
(12) Patent Application Publication
(10) Pub. No.: US 2003/0161040 A1
(43) Pub. Date: Aug. 28, 2003

(54) Stereoscopic image display device and electronic apparatus

(75) Inventors: Motonaga Ishii, Yokohama-shi (JP); Atsushi Miyazawa, Kawasaki-shi (JP); Masaaki Hanada, Yokohama-shi (JP)

Correspondence Address: OLIFF & BERRIDGE, PLC, P.O. BOX 19928, ALEXANDRIA, VA, 22320, US

(73) Assignee: NAMCO LTD., Tokyo (JP)

(21) Appl. No.: 10/359,102

(22) Filed: Feb. 6, 2003

(30) Foreign Application Priority Data
Feb. 26, 2002 (JP) 2002-050244
Nov. 12, 2002 (JP) 2002-327995

(51) Int. Cl. G02B 27/22

(52) U.S. Cl. 359/463; 359/462; 345/204

(57) ABSTRACT

A stereoscopic image display device comprising a display panel for displaying an image with a plurality of pixels and a lens plate with a plurality of lenses, to enable stereoscopic image viewing about an image displayed on the display panel through the lens plate. The display device further comprises a distance changing member for changing a distance between the display panel (20) and the lens plate (10) by moving the lens plate.

### BACKGROUND OF THE INVENTION

1. Field of the Invention

The present invention relates to a stereoscopic image display device which enables stereoscopic image viewing about an image displayed on a display panel, through a lens plate, and to an electronic apparatus which is provided with or connected with the stereoscopic image display device.

Recently, many types of stereoscopic image display device have been developed. Here, the stereoscopic image display device is one utilizing parallax of both eyes. That is, because both eyes are positioned horizontally apart from each other, parallax images are generated on right and left eyes of a human being so as to visually recognize them as a stereoscopic image. The stereoscopic image display device is one which realizes a stereoscopic image viewing by generating the right and left eyes parallax images intentionally. Although a general display device, e.g., a general television, a general display for a computer or the like, makes right and left eyes of an observer recognize the same image, the stereoscopic image display device makes the right and left eyes recognize images different from each other, i.e., a little parallax images.

There are various methods which make the right and left eyes recognize images different from each other. A display method using a lens plate, which is one of them attracts public attention because of an unnecessary large-scaled apparatus and relatively easy formation of images. This is a method in which a lens plate is attached onto a display screen to allow an observer to see the display screen through the lens plate. Generally, a plurality of lenses are integrated on the lens plate. The lens pitch of the lenses corresponds to a plurality of pixels, and each lens gives a directivity to light emitted from each pixel. Concretely, each lens refracts lights so as to visually recognize different pixels, depending on view point positions. Accordingly, when an observer observes the display screen from an ideal position through the lens plate, right and left eyes which are apart from each other, catch different images from each other so as to visually recognize them as a stereoscopic image.

In order to put such a stereoscopic image display device to practical use, it is preferable that both a two-dimensional image display, i.e., an image display that an observer recognizes by giving the same image to both eyes, and a stereoscopic image display can be performed, and switching the image display from one to the other can be easily performed. However, no prior art regarding the technique that two-dimensional and stereoscopic image viewings can be switched to display, have been found.

As described above, the stereoscopic image display device using a lens plate realizes the stereoscopic image viewing by each lens giving a directivity to light from each pixel. Therefore, the simplest manner to switch two-dimensional and stereoscopic image viewings in a stereoscopic image display device is to have steps of, installing a detachable lens plate when performing a stereoscopic image viewing, and removing the lens plate when performing a two-dimensional image viewing. However, because the lens plate determines the path of light from each pixel, arrangement of the lens plate is required to be set in an accuracy of micron order. Accordingly, it is relatively difficult to set the lens plate at an accurate position every switching from a two-dimensional image viewing to a stereoscopic image viewing, and therefore the structure with a detachable lens plate is not practical.

In the stereoscopic image display device using a lens plate, each of right and left eyes recognizes an image different from each other through the lens plate. That is, the direction for viewing each pixel is previously determined and therefore each pixel is to display the image information which corresponds to the direction for viewing. For example, viewing directions of pixels “a”, “b”, “c”, are previously determined depending on the lens plate, to be the directions for the right eye, for the left eye, for the right eye, . . . , respectively. Although a two-dimensional image viewing can be also realized by displaying the same image in every direction, such a construction arises a problem of resolution drop of image because the number of pixels which each eye recognizes through the lens plate is reduced than the number of pixels existing on the real displaying screen. As a result, such a construction provides only a poor quality of image in comparison with that of a display of television, computer or the like. Particularly, in a color stereoscopic image display device having such a construction, because each of color elements on the display device is enlarged and displayed, a chromatic moire, e.g., occurrence of vertically striped pattern on a picture, is generated. Accordingly, in case of displaying an image with clear contrast, e.g., a character or the like, it is hard for an observer to recognize the image clearly.

### SUMMARY OF THE INVENTION

The invention has been made in the light of the background art discussed above. It is therefore an object of the present invention to provide a stereoscopic image display device which enables switching between two-dimensional and stereoscopic image viewings easily, with no resolution drop of image in a two-dimensional image viewing.

In accordance with one aspect of the present invention, the stereoscopic image display device comprises: a display panel (for example, LC panel 130 shown in FIG. 10) for displaying an image with a plurality of pixels and a lens plate (for example, lens plate 120 shown in FIG. 10) with a plurality of lenses, to enable stereoscopic image viewing about an image displayed on the display panel through the lens plate, further comprising: a distance changing member (for example, shafts 170a-170d shown in FIG. 10) for changing a distance between the display panel and the lens plate by moving the lens plate.

The stereoscopic image display device comprising a lens plate with a plurality of lenses, includes one in which the lens pitch of lens plate corresponds to a plurality of pixels and the distance between the display panel and the lens plate is set so as to visually recognize different pixels, depending on positions for viewing a lens, for example, one having an arrangement so that the focal point of the lens is in the vicinity of the displaying surface of the display panel. According to such an arrangement construction, each pixel of the display panel comes to be enlarged up to a large size by each lens through the lens plate, and different pixels are observed depending on positions for viewing the lens. Therefore, when realizing a stereoscopic image viewing, the number of pixels which can be recognized through the lens plate is smaller than that of pixels existing on the display panel.

According to the invention, in the stereoscopic image display device, it is possible to change the distance between the display panel and the lens plate by moving the lens plate. Therefore, when arranging the display panel at a position at which the distance between the principal point and the display panel equal to twice the focal length of the lens, by moving the lens plate, it is possible for an observer to recognize all pixels of the display panel even through the lens plate. That is, it is possible to realize a two-dimensional image viewings easily with no resolution drop of image, in a stereoscopic image display device.

In order to change the distance between the display panel and the lens plate, not only moving the lens plate but also moving the display panel may be adopted. That is, in a stereoscopic image display device comprising a display panel for displaying an image with a plurality of pixels and a lens plate with a plurality of lenses, to enable stereoscopic image viewing about an image displayed on the display panel through the lens plate, the display device may further comprises: a distance changing member for changing a distance between the display panel and the lens plate by moving the display panel.

In the stereoscopic image display device, the distance changing member may enable moving the lens plate to at least two positions of a first position for a stereoscopic image viewing (for example, the position at which the distance between the principal point and the display panel equal to the focal length of the lens) and to a second position for a two-dimensional image viewing (for example, the position at which the distance between the principal point and the display panel equal to twice the focal length).

In the stereoscopic image display device, the distance changing member may enable moving the display panel to at least two positions of a first position for a stereoscopic image viewing and to a second position for a two-dimensional image viewing.

According to such a construction, it is possible to move the lens plate or the display panel to at least two positions of a first position for a stereoscopic image viewing and to a second position for a two-dimensional image viewing. As a result, it is possible to change the distance between the lens plate and the display panel, to switch the display state between a stereoscopic image viewing and a two-dimensional image viewing, according to the type of image to display on the display panel (for example, an image for stereoscopic viewing or an image for two-dimensional viewing).

In the above described stereoscopic image display device, the distance changing member may comprise a first holding member (for example, a stopper 223 shown in FIG. 15) for holding the lens plate at the first position.

In the stereoscopic image display device, the distance changing member may comprise a first holding member for holding the display panel at the first position.

According to such a construction, it is possible to hold the lens plate or the display panel at the position for stereoscopic image viewing. Therefore, it is possible to realize a stable stereoscopic image viewing without changing of the positional relationship between the lenses on the lens plate and pixels of the display panel.

In the stereoscopic image display device, the distance changing member may comprise a second holding member (for example, a stopper 223 shown in FIG. 15) for holding the lens plate at the second position.

The distance changing member may comprise a second holding member for holding the display panel at the second position.

According to such a construction, it is possible to hold the lens plate or the display panel at the position for two-dimensional image viewing. Therefore, it is possible to realize a stable two-dimensional image viewing without changing of the positional relationship between the lenses on the lens plate and pixels of the display panel.

The stereoscopic image display device may further comprises a guide member (for example, cam plates 902 and 904, slider 912, and cam holes 908, as shown in FIGS. 25A-25F; and cam ring 914 shown in FIGS. 26A-26D) for guiding the lens plate to move in a predetermined direction.

The above stereoscopic image display device may further comprises a guide member for guiding the display panel to move in a predetermined direction.

According to the display device having such a guide member, it is possible to move the lens plate or the display panel to a desired direction with preventing deviation of the lens plate or the display panel. Therefore, when switching the display state between a stereoscopic image viewing and a two-dimensional image viewing, it is possible to obtain a stable appropriate positional relationship between the lenses on the lens plate and pixels of the display panel.

In the stereoscopic image display device, the guide member (for example, supporting columns 160a-160d shown in FIG. 10, and holes 128a-128d each having a L-shaped section, shown in FIG. 11) may limit movement of the lens plate in a direction parallel to a displaying surface of the display panel and may guide the lens plate to move in a direction perpendicular to a displaying surface of the display panel.

In the stereoscopic image display device, the guide member may limit movement of the display panel in a direction parallel to the lens plate and may guide the display panel to move in a direction perpendicular to a flat surface of the lens plate.

According to the display device having such a guide member, it is possible to move the lens plate or the display panel in a direction parallel to the surface of each other member. Therefore, it is possible to obtain a stable appropriate positional relationship in the surface direction between the lenses on the lens plate and pixels of the display panel and to maintain a high quality of display.

In the stereoscopic image display device, the guide member (for example, cam plates 902 and 904, cam holes 908, and slider 912, as shown in FIGS. 25A-25F; and cam ring 914 shown in FIGS. 26A-26D) may guide the lens plate to move and slide in a predetermined direction and guide the lens plate to move in a direction perpendicular to a displaying surface of the display panel.

The guide member may also guide the display panel to move and slide in a predetermined direction and guide the display panel to move in a direction perpendicular to a flat surface of the lens plate.

According to such a construction, it is possible to change the distance between the lens plate and the display panel only by sliding the lens plate or the display panel. Therefore, it is possible to switch the state of display image viewing by a simple sliding operation.

In the stereoscopic image display device, the guide member may guide the lens plate to move and slide in a direction along a predetermined arrangement direction of the pixels of the display panel.

While sliding the lens plate or the display panel, the positional relationship between the lens plate and pixels of the display panel is out of an appropriate condition temporarily. Concretely, when conditions that the boundary of lenses of the lens plate does not coincide with the boundary of pixels of display panel, occur intermittently, a visible state like a flicker occurs.

According to such a construction, because the lens plate or the display panel can be slid in a direction along an arrangement direction of the pixels of the display panel, it is possible to remove or reduce the time of the positional relationship between the lens plate and pixels being out of an appropriate condition. Therefore, even when sliding the lens plate or the display panel, it is possible to maintain the display quality when switching. For example, in case of each lens on the lens plate has a long shaped structure in a predetermined direction such as a half-cylindrical shape, when conforming the longitudinal direction of the lens plate to the arrangement direction of pixels, it is possible to maintain an appropriate positional relationship between the lens plate and pixels of the display panel even during an essential sliding operation.

In the stereoscopic image display device, the guide member (for example, cam ring 914 shown in FIGS. 26A-26D) may guide a sliding movement of the lens plate in a rotational direction.

According to such a construction, it is possible to change the distance between the lens plate and the display panel by rotating the lens plate. When the rotational axis of the lens plate is set to coincide with the center of the display panel, projection of the lens plate out of the cam ring (914) by rotation (sliding operation) the lens plate can be prevented. Thus, such a construction has the effect of providing a small-sized stereoscopic image display device.

In the stereoscopic image display device, the distance changing member may comprise a member having a inclined surface (for example, sliding surface 302 shown in FIG. 18, and slope portion 908c shown in FIG. 25) of a predetermined angle (for example, insertion member 300 shown in FIG. 18; and cam plates 902 and 904 shown in FIGS. 25A and 25B) to change the distance between the display panel and the lens plate by moving the lens plate along the inclined surface.

The distance changing member may comprise a member having an inclined surface of a predetermined angle, to change the distance between the display panel and the lens plate by moving the lens plate along the inclined surface.

For example, in case that movement of the lens plate is limited and the member having an inclined surface is moved, the change of the distance between the display panel and the lens plate can be set by controlling the speed of movement of the member and the angle of the inclined surface, as desired.

Therefore, according to such a construction, it is possible not only to obtain the advantageous effects similar to that of the above described invention but also to change the positional relationship between the display panel and the lens plate by controlling the length and the angle of the inclined surface, as desired.

The stereoscopic image display device may further comprise a driving member unit (for example, driving unit 840 and operation control unit 850, shown in FIG. 24, more concretely, electromagnets 360a-360d shown in FIG. 19) for driving the distance changing member in response to a driving signal input from the outside.

According to such a construction, it is possible to set to change the distance between the display panel and the lens plate in response to a driving signal input from an external apparatus, for example, a personal computer, a game apparatus or the like, which is connected to the stereoscopic image display device of the invention.

The stereoscopic image display device (for example, stereoscopic image display device 700 shown in FIG. 23), may further comprises an output unit (for example, operation control unit 850 shown in FIG. 24, more concretely, a switch including contacts “A”, “B” and “C” shown in FIG. 18D) for outputting a notification signal to an external device according to an operating state of the distance changing member.

According to such a construction, a notification signal according to an operating state of the distance changing member is output to an external device. Thus, the invention having such a construction is effective particularly in case of displaying on the display panel image data input from an external apparatus which is connected to the stereoscopic image display device of the invention. That is, the construction enables giving an instruction to external apparatus to output image data corresponding to the positional relationship (operating state of the distance changing member) between the display panel and the lens plate.

In accordance with another aspect of the present invention, the electronic apparatus comprises: the stereoscopic image display device as claimed in claim 20; an image control unit (for example, CPU 600 shown in FIG. 21, and steps S3 and S5 in switching process shown in FIG. 22) for switching image information between image information for stereoscopic viewing and image information for two-dimensional viewing, to output the image information to the stereoscopic image display device; and an instruction output unit (for example, CPU 600 shown in FIG. 21, and steps S2 and S4 in switching process shown in FIG. 22) for outputting a driving signal for driving the driving unit, coupled to switching of output image information by the instruction output unit.

According to the electronic apparatus, it is possible to change the distance between the lens plate and the display panel, depending on the type of image to be displayed, i.e., an image for stereoscopic viewing or an image for two-dimensional viewing. Therefore, for example, in case of using the electronic apparatus as a game apparatus, it is possible to set to switch the distance between the lens plate and the display panel, so as to switch the type of image to be formed and displayed in stages of the game on the basis of the game program.

The electronic apparatus connected to the stereoscopic image display device, may further comprises an image control unit for switching image information between image information for stereoscopic viewing and image information for two-dimensional viewing in response to a notification signal output from the output unit, to output the image information to the stereoscopic image display device.

In the electronic apparatus having such a construction, types of image to be output to the stereoscopic image display device, i.e., an image for stereoscopic viewing and an image for two-dimensional viewing, are switched in response to a notification signal input from the stereoscopic image display device. For example, it is possible to realize an electronic apparatus having a simple structure so that when a notification signal generated by an input button pressed down is output to the electronic apparatus, the electronic apparatus changes the image data so as to be output to the stereoscopic image display device according to the notification signal.

An arrangement of a lens plate and a display panel, in which the lens principal point to display surface distance is equal to about twice the focal length of the lens, is considered to realize a two-dimensional viewing. Although such an arrangement enables an observer observing an image of full size through the lens plate about the portion of display panel opposed to the lens, the visible image observed through the lens plate has an inverse arrangement thereof.

In order to solve such a problem, the image control unit in the electronic apparatus may comprise an image changing unit (for example, CPU 600 shown in FIG. 21, and step S5 in switching process shown in FIG. 22) for changing an arrangement construction of image information for pixels which form an image information for a two-dimensional image viewing.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a vertical sectional view of two-view stereoscopic image display device;

FIG. 2 is a view for explaining the difference between the positions for viewing the lens plate and pixels;

FIGS. 3A and 3B are views for explaining images when viewing the two-view stereoscopic image display device with a right eye;

FIGS. 4A and 4B are views for explaining five-view stereoscopic image display device;

FIGS. 5A and 5B are views for explaining a process for replacing image information in a monochromic stereoscopic image display device;

FIGS. 6A and 6B are views for explaining a process for replacing color information in a color stereoscopic image display device;

FIG. 7 is a view showing an example of color elements arrangement which are visible through the lens plate;

FIG. 8 is a view showing an example of color elements arrangement which are visible through the lens plate in a stereoscopic image viewing;

FIGS. 9A and 9B are views for explaining a type of stereoscopic image display device in which the uneven surface of a lens plate is not opposed to the displaying surface of the LC panel;

FIG. 10 is a schematic front view of a stereoscopic image viewing display device having a switching mechanism 1;

FIG. 11 is a plan view of a lens plate;

FIG. 12A is a perspective view of the rear side of the fixed plate, FIG. 12B is a partially sectional view of an adjusting screw and a cap, and FIG. 12C is a perspective view of the rear side of stereoscopic image viewing display device;

FIG. 13 is a schematic front view showing a type of stereoscopic image viewing display device in which the fixed plate is movable;

FIG. 14 is a schematic vertical sectional view of a stereoscopic image viewing display device having a switching mechanism 2;

FIG. 15 is a perspective view of a cam portion;

FIG. 16 is a view for explaining the operation of cam body;

FIG. 17 is a sectional view of stereoscopic image viewing display device of a type in which both the lens plate and the LC panel are movable;

FIG. 18A is a perspective view of an insertion member, FIG. 18B is a sectional view of a type of stereoscopic image viewing display device in which the uneven surface of the lens plate and the displaying surface of LC panel are opposed to each other, FIG. 18C is a sectional view of a type of stereoscopic image viewing display device in which the uneven surface of the lens plate and the displaying surface of LC panel are not opposed, and FIG. 18D is a sectional partial view for showing a switch structure of the insertion member and the stereoscopic image viewing display device;

FIG. 19 is a schematic vertically sectional view of a stereoscopic image viewing display device having a switching mechanism 4;

FIG. 20 is a perspective view of a small-sized electronic apparatus;

FIG. 21 is a block diagram showing an embodiment of hardware construction of the small-sized electronic apparatus;

FIG. 22 is a flow chart showing an embodiment of the switching process;

FIG. 23 is a perspective view of a stereoscopic image viewing display device which can be connected to an external device;

FIG. 24 is a block diagram showing an embodiment of hardware construction of the stereoscopic image viewing display device shown in FIG. 23;

FIGS. 25A-25C show an embodiment of stereoscopic image viewing display device having such an switching mechanism, in a stereoscopic image viewing, in which FIGS. 25A, 25B and 25C are a schematically plan view, a schematically vertically sectional front view (N-N′ section), and a schematically vertically sectional side view (M-M′ section), thereof, respectively; and FIGS. 25D, 25E and 25F show the embodiment in a two-dimensional image viewing, in which 25D-25F are a schematically plan view, a schematically vertically sectional front view (N-N′ section), and a schematically vertically sectional side view (M-M′ section), thereof, respectively;

FIGS. 26A and 26B are a schematic plan view and a schematically vertically sectional view (D-D′ section), of an embodiment of stereoscopic image viewing display device having an switching mechanism 6, respectively, FIG. 26C is a schematic plan view of the embodiment for explaining the lens plate with a slider, and FIG. 26D is an exploded side view of the cam ring in the switching mechanism;

FIGS. 27A-27C are plan views showing successive states of the switching mechanism 6, for explaining an operation manner thereof; and

FIG. 28A is a plan view showing an embodiment of the switching mechanism 6 having a mechanism for fine adjustment, and FIG. 28B is a partially sectional view of the mechanism for fine adjustment (E-E′ section).

### DETAILED DESCRIPTION OF THE PREFERRED EMBODIMENT

Hereinafter, embodiments of the present invention will be explained with reference to the drawings.

In the embodiments, a stereoscopic image display device using a lens plate, which enables switching between the stereoscopic image display and the two-dimensional image display easily and a method for realizing a two-dimensional image display with an image resolution approximately equivalent to that of the case when the lens plate is removed, will be explained in detail.

Only a case of using a two-dimensional liquid crystal display as the image display means for the stereoscopic image display device will be explained, as follows. However, applications of the present invention are not restricted to the above-described case. As the lens plate installed in the stereoscopic image display device, various types thereof, for example, the so-called fly eye lens which comprises a number of small lenses arranged in matrix, and the like can be adopted. In the following embodiment, a lenticular lens plate is used as the lens plate.

The lenticular lens plate is a lens plate which has an uneven surface and an approximately even surface. The uneven surface is formed by a plurality of half-cylindrical lenses or a plurality of lenses optically equivalent to them, which are arranged successively. The lenticular lens plate is disposed on the two-dimensional liquid crystal display so that the side surfaces of each of the half-cylindrical lenses correspond to the arrangement in the longitudinal direction of each of the pixels. In the specification, a lenticular lens plate will be also called as a lens plate simply.

First, an embodiment of the stereoscopic image display device will be explained.

In order to simplify the explanation, an example of two-view stereoscopic image display device will be explained. Here, the two-view display means a display for displaying different images with respect to respective two viewing directions.

FIG. 1 is a view showing a schematic section perpendicular to the displaying surface of the two-view stereoscopic image display device 1. Precisely, FIG. 1 is a view showing a section perpendicular to the lateral direction, i.e., to the line parallel to the line including both eyes of the observer, on the displaying surface of the stereoscopic image display device 1. Referring to the figure, the stereoscopic image display device 1 comprises a lens plate 10, a liquid crystal (LC) panel 20, and a backlight 30. Each member of lens plate 10, LC panel 20 and backlight 30 has an approximate plate-like shape. These members are arranged in parallel to one another. Light emitted from backlight 30 is transmitted through LC panel 20 and lens plate 10, and travels out of stereoscopic image display device 1. Accordingly, the observer observes images which are displayed on LC panel 20 through lens plate 10.

Lens plate 10 is arranged and designed so that the uneven surface 10a of the lens plate faces to the displaying surface 20a of LC panel 20 and the lateral pitch “X” of each lens corresponds to that of two pixels. In order to realize displaying a stereoscopic image in stereoscopic image display device 1 shown in FIG. 1, generally, the distance between lens plate 10 and LC panel 20 is adjusted to coincide with the focal length of each lens of lens plate 10. That is, lens plate 10 and LC panel 20 are disposed so that the focal point of each lens is positioned in the vicinity of the displaying surface 20a of LC panel 20. As a result, each pixel of LC panel 20 comes to be enlarged up to a large size by each lens of lens plate 10. Each lens gives directivity to the light emitted from each pixel of LC panel 20.

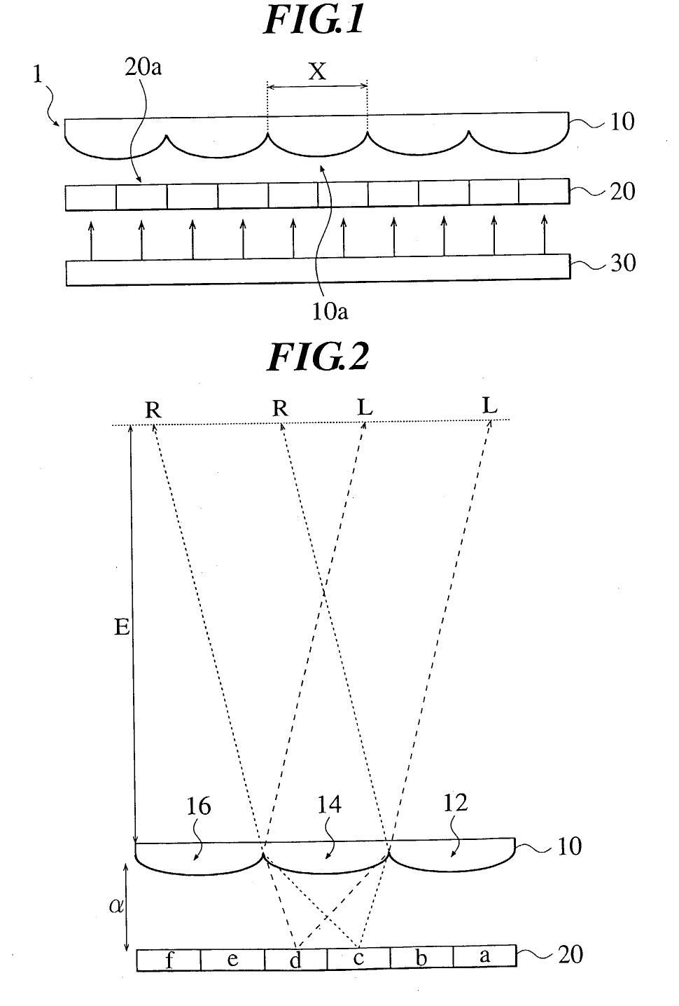

FIG. 2 is a schematically sectional view showing lens plate 10 and LC panel 20 partially. In this figure, the distance between lens plate 10 and LC panel 20 is adjusted to coincide with the focal length a of each lens of lens plate 10. In LC panel 20, a plurality of pixels “a”, “b”, “c”, “d”, “e” and “f” are arranged. The pitch “X” of each lens of lens plate 10 corresponds to that of two pixels, like the above-described case. When an observer looks at the lens 14 in the stereoscopic image display device 1 set as above-described from an ideal distance “E” by the left eye “L”, the pixel “d” enlarged up to the whole area of the lens 14 can be seen because the focal point of lens 14 is positioned at the pixel “d”. On the other hand, when the observer looks at the lens 14 by the right eye “R”, the pixel “c” enlarged up to the whole area of the lens 14 can be seen because the focal point of lens 14 is positioned at the pixel “c”. As described above, by setting of the focal point of each lens of lens plate 10, which is positioned in the vicinity of the displaying surface 20a of LC panel 20, both eyes of the observer can recognize different images from each other.

On the basis of the above construction, a method for switching between the stereoscopic image viewing and the two-dimensional image viewing will be explained in detail.

In the design of the above-described stereoscopic image display device, only one pixel can be seen through a lens for each of the viewing directions, in order to realize a stereoscopic image viewing. Accordingly, when displaying a stereoscopic image, the number of pixels which can be seen through lens plate 10 is less than that of pixels of LC panel 20. For example, in the stereoscopic image display device 1 as shown in FIG. 1, because the number of pixels corresponding to the lens pitch “X” is 2, the resolution of image which is recognized by a single eye is ½ of the actual resolution of LC panel 20.

In order to realize a two-dimensional image viewing, because easiness to see an image is required rather than stereoscopy, it is preferable that each of both eyes recognize the same image in approximately the same resolution as that of LC panel 20. For convenience for the stereoscopic image display device, it is required to allow switching between the stereoscopic image viewing and the two-dimensional image viewing without removing lens plate 10.

In an embodiment of the present invention, a two-dimensional image viewing is realized by making the number of pixels to be seen through a lens equal to that of pixels corresponding to the pitch “X” of the lenses, by adjusting the distance between lens plate 10 and LC panel 20. Hereinafter, the distance between the principal point corresponding to the convex surface of the lens and the LC panel may be called as the principal point to display surface distance.

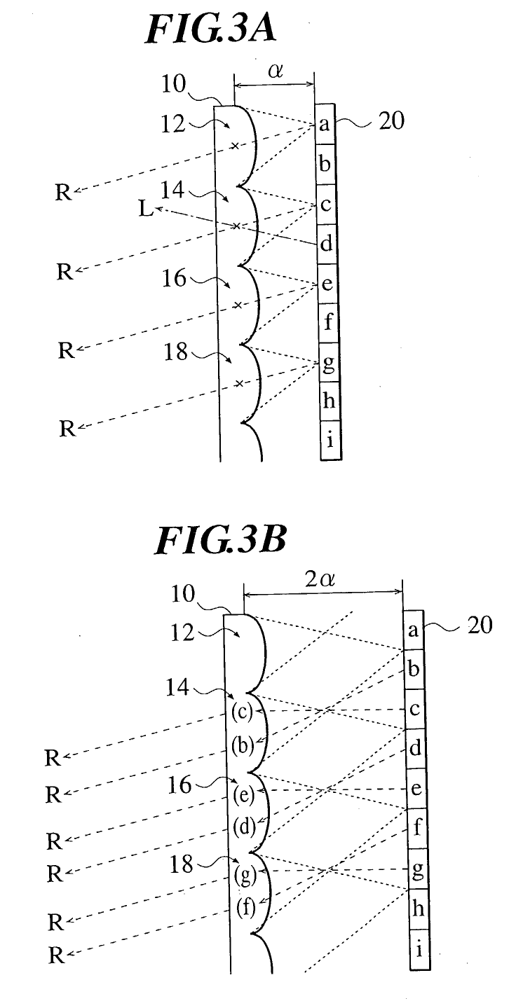

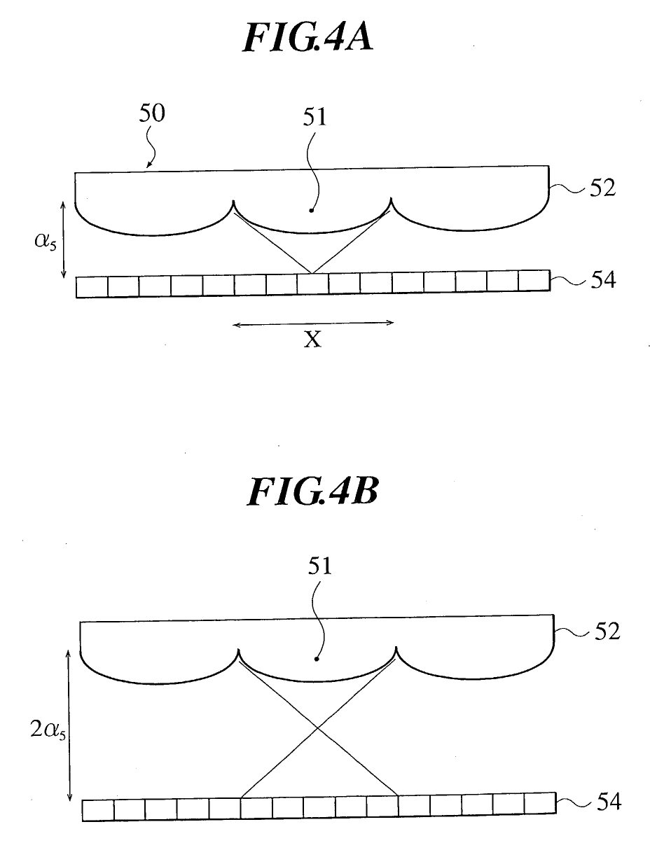

FIGS. 3A and 3B are views for explaining an image which is observed by the right eye “R” when observing the stereoscopic image display device 1 at an ideal position. FIG. 3A is a schematic view showing the optical path of light when displaying a stereoscopic image. In the figure, the principal point to display surface distance “d” and the focal length “α” of the lens satisfies: d=α. In FIG. 3A, because the focal point of the lens is positioned at the pixel “c” when observing by the right eye “R”, an enlarged image of the pixel “c” is observed through the lens 14. Similarly, enlarged images of the pixel “e” and “g” are observed through the lenses 16 and 18, respectively. When observing by the left eye “L”, enlarged images of the pixel “d”, “f” and “h” are observed through the lenses 14, 16 and 18, respectively. FIG. 3B is a schematic view showing the optical path of light when displaying a two-dimensional image. In the figure, the principal point to display surface distance “d” and the focal length “α” of the lens satisfies: d=2α. In the figure, while the focal point of each lens is the same as that of the case of FIG. 3A when observing by the right eye “R”, because the principal point to display surface distance “d” is equal to 2α, the number of pixels which are observed through each lens is the same as that of pixels corresponding to the pitch “X” of the lenses. Concretely, images of the pixels “b” and “c” are observed through the lens 14 in a state of the arrangement of the pixels replaced with each other; and images of the pixels “d” and “e” are observed through the lens 16 in a state of the arrangement of the pixels replaced with each other; and images of the pixels “f” and “g” are observed through the lens 18 in a state of the arrangement of the pixels replaced with each other. Similarly, when observing by the left eye “L”, images of the pixels corresponding to a respective lens are observed through the lens in a state of the arrangement of the pixels replaced with each other.

As described above, changing the principal point to display surface distance “d” from “d=α” to “d=2α”, allows to change the number of pixels which are observed through each lens to that of pixels corresponding to the pitch “X” of the lenses, to enables both eyes of the observer recognizing all pixels of LC panel 20.

In the above explanation, although only an embodiment of two-view stereoscopic image display device is described, the present invention is not limited such a type and can be applied to another type thereof, e.g., three-view, four-view, five-view, or the like.

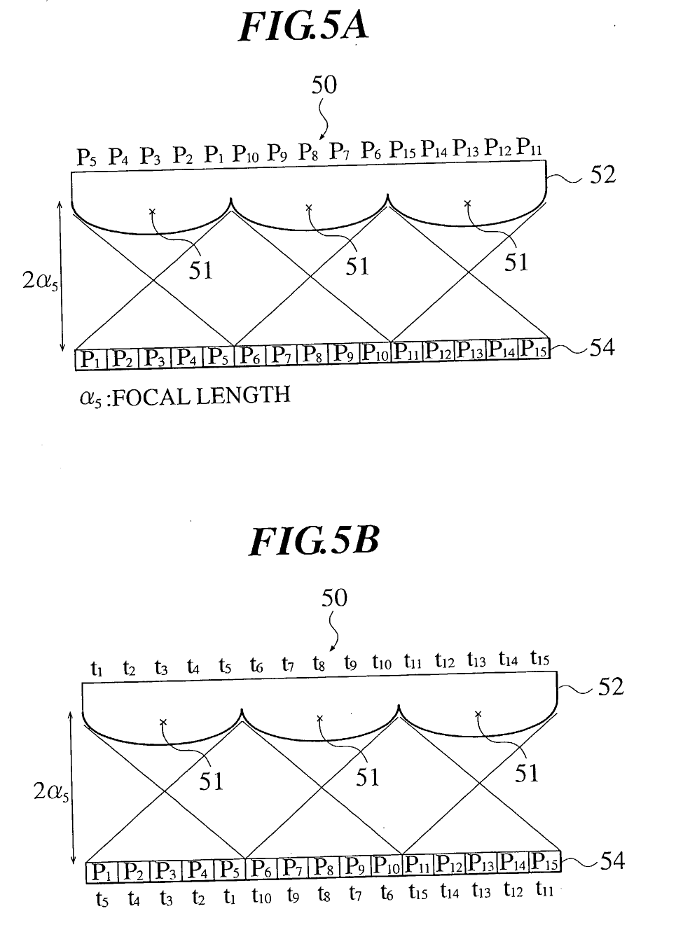

FIGS. 4A and 4B are a view explaining an embodiment of five-view stereoscopic image display device 50. FIG. 4A is a schematic view showing a lens plate 52 and a LC panel 54 when displaying a stereoscopic image. The five-view stereoscopic image display device 50 displays different images for five viewing directions. Therefore, when seeing the lens in the five viewing directions, different pixels from one another can be recognized. Concretely, the lateral lens pitch “X” of lens plate 52 is designed to correspond to the length of five pixels of LC panel 54. In order to realize displaying a stereoscopic image, lens plate 52 and LC panel 54 are arranged so that the distance between the principal point 51 of each lens and LC panel 54 coincides with the focal length α₅ of each lens. Although the principal point 51 is expressed to be inside the lens in this figure, the position of the principal point is not limited to this.

FIG. 4B is a brief sectional view of lens plate 52 and LC panel 54 when displaying a two-dimensional image, and shows the optical path of the light emitted from a backlight schematically. In the figure, the principal point to display surface distance “d” and the focal length “α” of the lens satisfies: d=2α₅ (α₅: focal length). Therefore, when observing the stereoscopic image display device 50 at an ideal position, five individual pixels can be recognized through each lens.

As described above, it is possible to easily switch from a stereoscopic image viewing to a two-dimensional image viewing by changing the principal point to display surface distance “d” from “α” to “2α”, without depending on the number of viewing directions, e.g., two-view, five-view or the like.

Generally, when seeing an object which is located more than the focal length of the lens apart, through a convex lens, an inverse image of the object is visible. Accordingly, in displaying a two-dimensional image (d=2α), the lineup order of the pixel images which are observed through each lens is the reverse of that of the pixels in the real LC panel.

FIG. 5A is a view for explaining the state of inverse lineup order of the pixels in a five-view stereoscopic image display device which uses a monochromic LC display. In this figure, the principal point 51 of each lens and LC panel 54 are arranged a principal point to display surface distance “d” which is equal to 2α apart. In LC panel 54, the order of arrangement of pixels are P₁, P₂, P₃, P₄, P₅, P₆, . . . , from the left. When observing LC panel 54 through the lens plate 52, the arrangement order of the pixel images comes to be the reverse of that of the pixels under the influence of each lens. That is, the pixel images come to be visible in order of P₅, P₄, P₃, P₂, P₁, P₁₀, P₉, P₈, . . . , from the left.

This problem is aggravated with fineness of an image displayed on LC panel 54. For example, when an image with a relatively low contrast or a relatively rough image is displayed on LC panel 54, an image which is observed through lens plate 52 suffers almost nothing by comparison with the original image and practically introduces no problems. However, when a precise character or the like, such as a character with pixels each of which has a different display state to one another, it may be hard to recognize the image by replacement of pixels. In order to solve such a problem, it is preferable to replace the image information to be displayed on pixels, previously when displaying a two-dimensional image. For example, as shown in FIG. 5B, the image information t₅ which should be seen essentially at the position of pixel P₅ is displayed by the pixel P₁ of LC panel 54. Similarly, the image information t₄ which should be seen essentially at the position of pixel P₄ is displayed by the pixel P₂ of LC panel 54. Thus, the observer can recognize a two-dimensional image without a feeling of physical disorder by previously replacing the image information to be displayed on each pixel suitably.

The manner to replace the image information can be applied not only for a monochromic. LC display but also for a color LC display.

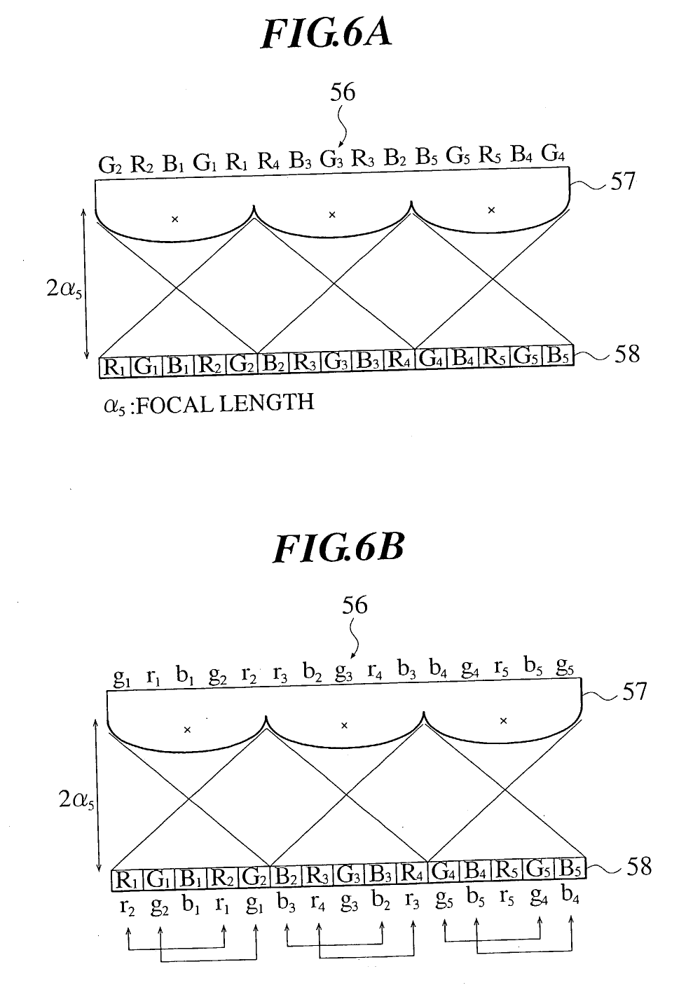

FIG. 6A is a view for explaining an example of changed lineup order of pixel arrangement in a five-view stereoscopic image display device 56 which uses a color LC display. In the color LC display, one pixel comprises three color elements (sub-pixels) of red (R), green (G) and blue (B). That is, the color for a pixel is expressed by blending (combining) the three color elements of RGB. In the LC panel 58, as shown in FIG. 6A, the color elements are arranged in the order of R, G and B. In this figure, the subscript attached to R, G or B shows a number of a pixel. The lens pitch “X” corresponds to five color elements. Therefore, when the principal point to display surface distance “d” is equal to a (focal length), different color elements can be recognized from five directions, respectively.

When observing the screen of the stereoscopic image display device 56 which uses a color LC display shown in FIG. 6A, by setting the principal point to display surface distance “d” to be equal to 2α, the arrangement of the images through the lens 57, of the color elements which are arranged in the order of R₁, G₁, B₁, R₂, G₂, B₂, R₃, . . . , from the left in LC panel 58, are changed to the order of G₂, R₂, B₁, G₁, R₁, R₄, . . . , from the left. As described above, because one pixel in a color LC display comprises adjacent three color elements, changing of the order of color elements results in that color element images for originally different pixels to one another form a pixel. As a result, there is a possibility of recognizing an image different from the original image displayed on the LC panel 58. In order to solve the problem, setting a previous replacement of color information on the LC panel so that images of three color elements to form one pixel are adjacent one another through the lens, is required.

FIG. 6B shows an example of previous replacement of the order of color elements. In the figure, the color information r₁ which should be essentially observed at the position of the color element R₁ is displayed at the position of the color element R₂ to realize a two-dimensional viewing. Similarly, the color information g₁ which should be essentially observed at the position of the color element G₁ is displayed at the position of the color element G₂. Thus, it is possible to mitigate a feeling of visual disorder which is caused by the effect of lens, by replacing the displaying positions of plural color information between color elements appropriately.

However, when the number of color elements corresponding to the lens pitch “X” does not conform to that of color elements of pixels, for example, when the number of color elements corresponding to the lens pitch “X” is 2, 4, 5, or the like, there is a possibility that the same type of color elements are adjacent to each other at the boundary positions of lenses, so that it looks emphasized color tone, as shown in FIG. 6B. The emphasis of color tone is a problem in a case of displaying an image with fine pixels, in particular, such as aligned pixels with primary colors different from one another, however, it is not an important problem in a case of displaying a general image, that is, an image expressed by gradients of intermediate colors mainly, not primary colors.

It is a matter of course preferable to perform an improvement that the observed tone of colors adjacent to each other at the boundary positions of lenses are not emphasized. Several methods for preventing emphasis of color tone can be found. An example thereof will be explained, as follows.

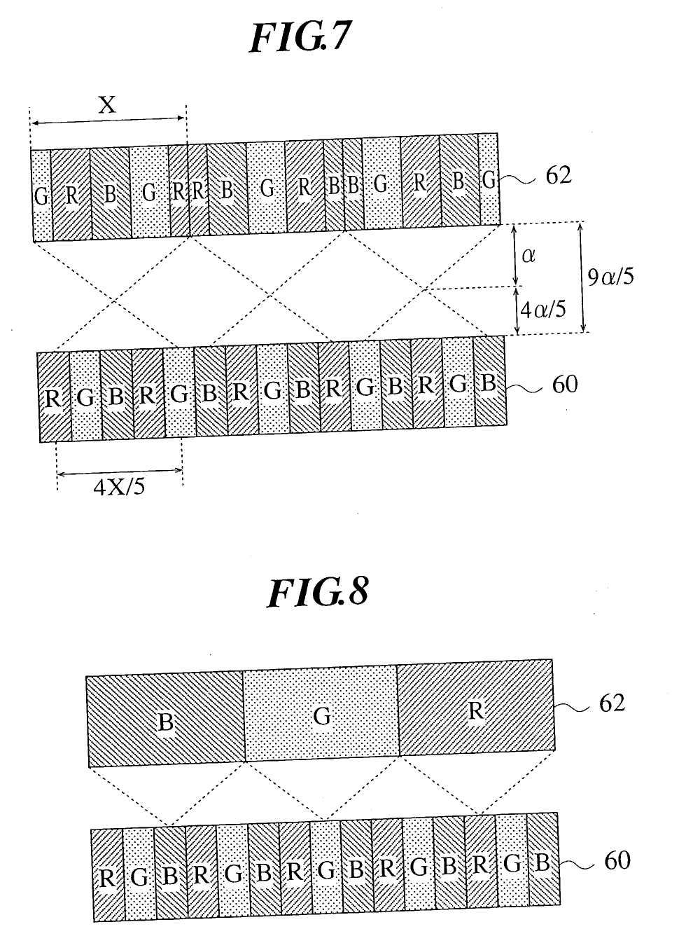

There is a method for adjusting the distance between a lens plate and an LC panel, to make the image width of successive color elements equivalent to one another. FIG. 7 is a view for explaining a case of making the image width of successive color elements equivalent to one another by adjusting the principal point to display surface distance “d” when observing color elements through the front surface of the lens plate from an ideal position. In this figure, the rectangular region 60 is a portion of the LC panel, and the rectangular region 62 is an image of color elements which is observed through a lens plate. In LC panel 60, the color elements are arranged in the order of R, G, and B. The lens pitch “X” of lens plate 72 corresponds to that of five color elements. In the figure, the principal point to display surface distance “d” to be equal to 9/5 times of the focal length α. Accordingly, the color elements within a region of 4X/5 are enlarged and displayed through each lens of lens plate 72. According to such a setting, it is possible to make the lateral widths of images of all the color elements equal to each other, as shown in FIG. 7. As a result, the emphasis of tone of colors adjacent to each other at the boundary positions of lenses can be prevented. Such a method is effective for various (3n+2)-view types, e.g., 5-view type, 8-view type, . . . , of stereoscopic image display device. In this case, preferably, the distance between the lens plate and the LC panel is equal to (2−1/n) times of the focal length thereof. Therefore, the principal point to display surface distance “d” for a two-dimensional viewing may not be equal to 2α. In the followings, the principal point to display surface distance for a two-dimensional viewing is set to be equal to α.

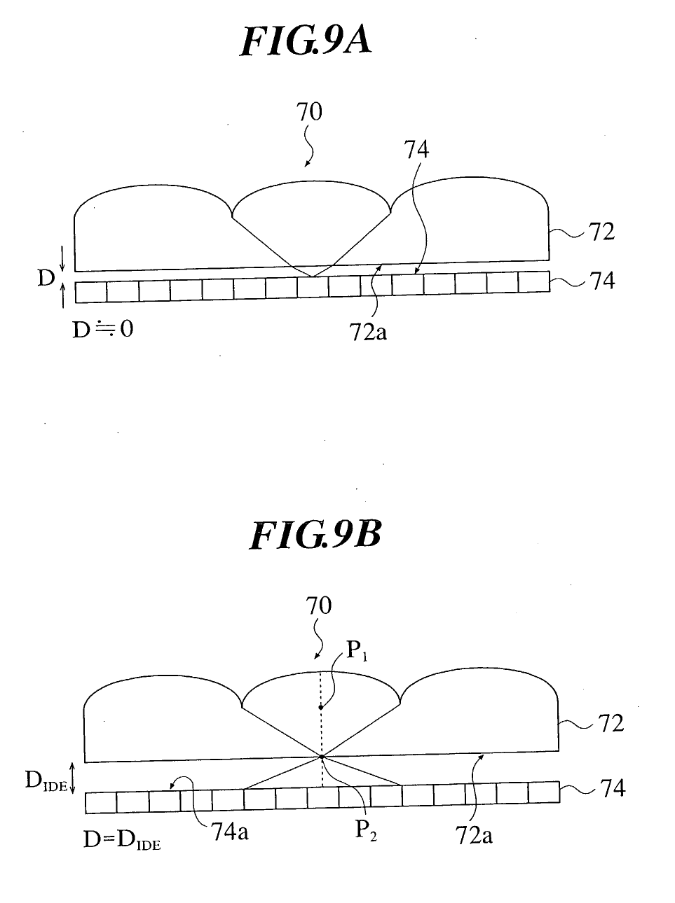

As described above, when images displayed in the viewing directions displaying are approximately equivalent to one another and the principal point to display surface distance “d” is equal to the focal length α, a two-dimensional viewing with an image resolution inferior than the essential one of the LC panel can be realized. FIG. 8 is a schematic view for showing the case of each of color elements of LC panel 60 which is enlarged through the lens plate 72, in a five-view stereoscopic image display device. In the stereoscopic image display device using a color LC display, it may be recognized that the color elements are separated from one another because the color elements are enlarged and displayed through respective lenses of the lens plate. Accordingly, in an image using color tones in which the luminance of the R, G and B color elements are different from one another, a chromatic moire, e.g., occurrence of vertically striped light and dark pattern on a picture with even images which should essentially have a uniform luminance, occurrence of primary-color boundary on monochromic characters, or the like is generated. Even if carrying out a two-dimensional viewing by displaying images which are approximately equivalent to one another in the respective viewing directions in this state, it is hard for an observer to recognize fine images because of the influence of the chromatic moire, and the observer cannot recognize specific images for a two-dimensional viewing. However, to adjust the distance between the lens plate and the LC panel, to set for an observer to be able to recognize all color elements on the LC panel through the lens plate, as described with reference to FIGS. 1-6, enables reduction of the chromatic moire and realization of a two-dimensional viewing with a high resolution.

In the above described embodiment, an example of an arrangement of the uneven surface of the lens plate and the LC panel which are opposed to each other, in a stereoscopic image display device is explained. In the case, a medium (air) is provided between the lens plate and the displaying surface of the LC panel. However, there is another type of stereoscopic image display device which comprises a lens plate the uneven surface of which is arranged in the observing side, and a LC panel the displaying surface of which is opposed to the flat surface of the lens plate. In such a case, the gap between the lens plate and the displaying surface of the LC panel comprises a layer of substance forming the lens plate and an air layer. In a case of such two layers in which the travelling speeds of light are different form each other, it is preferable to determine the distance “D” between the LC panel and the lens plate to realize an ideal two-dimensional viewing, as follows.

FIG. 9 is a schematic sectional view of an example of the type of stereoscopic image display device 70 in which the flat surface 72a of a lens plate 72 is opposed to the displaying surface 74a of a LC panel 74. In this figure, the focus of each lens of lens plate 72 is positioned in the vicinity of the flat surface 72a of lens plate 72. Therefore, when the distance “D” between the flat surface 72a of lens plate 72 and the displaying surface 74a of LC panel 74 is equal to “0”, a stereoscopic viewing I realized because the focus of each lens is positioned in the vicinity of the displaying surface 74a of LC panel 74, as shown in FIG. 9A.

In order to realize an ideal two-dimensional viewing image in the stereoscopic image display device 70 shown in FIGS. 9A and 9B, it is required to set the distance “D” between lens plate 72 and LC panel 74 with taking into consideration the index of refraction in a case of light travelling from lens plate 72 into the air. Concretely, the ideal distance D_{IDE} to realize a two-dimensional viewing is determined by:

D_{IDE}=βn (1)

where β is the distance P₁P₂ between the principal point P₁ and the intersection (i.e., focus) P₂ of the optical axis and the flat surface of lens plate 72, and n is the index of refraction from lens plate 72 into the air.

That is, when the distance “D” between lens plate 72 and LC panel 74 is equal to “0”, it is possible to display a stereoscopic viewing image; and when D=D_{IDE}, it is possible to display a two-dimensional viewing image.

As described above, in order to realize a two-dimensional viewing, the distance “D” between lens plate and LC panel is set so that all pixels corresponding to the lens pitch can be recognized through the lens when observing the lens plate at an ideal position. That is, in any type of stereoscopic image display device, it is possible to switch between the stereoscopic image viewing and the two-dimensional image viewing easily, only by adjusting the distance “D” between lens plate and LC panel.

Next, some embodiments of mechanism for switching the distance “D” between lens plate and LC panel will be explained. However, the method for switching the distance “D” between lens plate and LC panel is not limited to the following methods. Any structure which can switch the distance “D” between for a stereoscopic image viewing and a two-dimensional image viewing, can also be used.

(1) Switching Mechanism 1 (Shaft Type)

First, an embodiment in which a shaft is used as a switching mechanism for switching the distance “D” between lens plate and LC panel will explained, as follows.

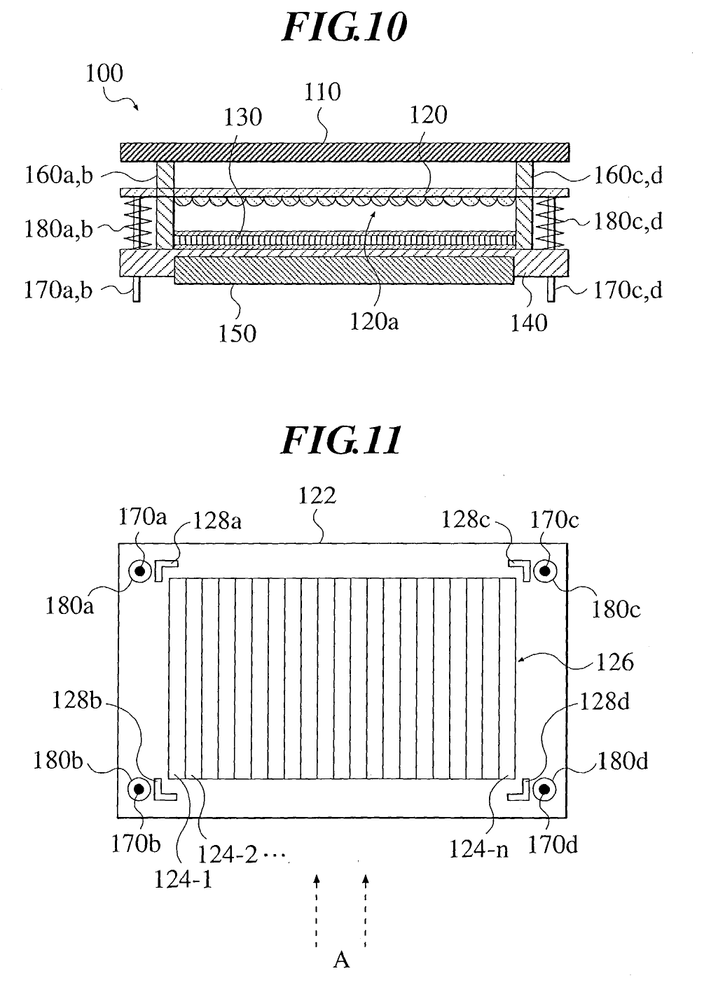

FIG. 10 is a schematic front view when seeing from the direction of arrows “A” in FIG. 11, showing an embodiment of a stereoscopic image viewing display device 100 having a mechanism for switching the distance “D” between lens plate and LC panel. The stereoscopic image viewing display device 100 comprises a protective glass 110, a lens plate 120, an LC panel 130, a fixed plate 140, a back light 150, four supporting columns 160a-160d, four shafts 170a-170d, and four coil springs 180a-180d.

Each of members except supporting columns 160a-160d, shafts 170a-170d and coil springs 180a-180d has a rectangular plate shape. The members are disposed in parallel to one another in the order of protective glass 110, lens plate 120, LC panel 130, fixed plate 140 and a back light 150. Protective glass 110 is transparent. When observing stereoscopic image viewing display device 100, an observer comes to observe lens plate 120 and LC panel 130 through protective glass 110.

The supporting columns 160a-160d are for mounting protective glass 110 to fixed plate 140. The upper ends of supporting columns 160a-160d are fixed to four corners of protective glass 110 and the lower ends thereof are fixed to four corners of fixed plate 140, so that supporting columns 160a 160d are parallel to one another. The fixed plate 140 is transparent. On the surface of fixed plate 140, which is opposed to protective glass 110, LC panel 130 is mounted in the center thereof. On the rear surface of fixed plate 140, back light 150 is mounted in the center thereof. That is, the light emitted from back light 150 is passed through fixed plate 140 to reach LC panel 130.

At the four corners of fixed plate 140, which are at further outer positions than supporting columns 160a-160d, circular holes are formed. Shafts 170a-170d pass through the circular holes, respectively, allowing fixed plate 140 to slide along shafts 170a-170d. The lower ends of coil springs 180a-180d are adhered to fixed plate 140. Coil springs 180a-180d are provided to surround the respective circular holes coaxially. Each radius thereof is larger than that of the circular holes. The upper ends of shafts 170a-170d and the upper ends of coil springs 180a-180d are adhered to lens plate 120. That is, shafts 170a-170d function to move lens plate 120 up and down because the upper ends of the shafts are adhered to lens plate 120 and the shafts pass through the circular holes of fixed plate 140, to slide up and down. The upper ends of coil springs 180a-180d are adhered to lens plate 120 and the lower ends thereof are adhered to fixed plate 140.

Lens plate 120 comprises a lens substrate 122 made of transparent material and a plurality of half cylindrical shaped lenses 124-1 to 124-n. FIG. 11 is a plan view of the uneven surface 120a of the lens plate 120. The half cylindrical shaped lenses 124-1 to 124-n are adhered to lens substrate 122 to occupy a rectangular region 126 formed in the central portion of the lens substrate. The half cylindrical shaped lenses 124-1 to 124-n are aligned in parallel to one another to correspond to the alignment of pixels of LC panel 130 which is opposed to the lenses. At the positions near and outside the four corners of rectangular region 126, four holes 128a-128d each having a L-shaped section which is similar to that of supporting columns 160a-160d are formed in lens substrate 122. That is, supporting columns 160a-160d pass through four holes 128a-128d, respectively, and lens plate 120 is movable in the direction parallel to supporting columns 160a-160d. To the four corner positions of lens substrate 122, which are further outside four holes 128a-128d, the upper ends of shafts 170a-170d and of coil springs 180a-180d are adhered, respectively.

In such a structure, coil springs 180a-180d function to separate lens plate 120 from fixed plate 140 by its elasticity. The distance between lens plate 120 and LC panel 140 can be changed by moving shafts 170a-170d in the direction parallel to supporting columns 160a-160d. Concretely, in order to realize a stereoscopic image viewing, shafts 170a-170d are moved in the lower direction in FIG. 10 so that the distance between lens plate 120 and LC panel 140 comes to be equal to the focal length a of half cylindrical shaped lenses 124-1 to 124-n. On the other hand, in order to realize a two-dimensional image viewing, shafts 170a-170d are moved in the upper direction in FIG. 10 so that the distance between lens plate 120 and LC panel 140 comes to be equal to α′ of half cylindrical shaped lenses 124-1 to 124-n. The protective glass 110 plays a role also as a stopper to movement of lens plate 120, to stop lens plate 120 at a position accurate to realize a two-dimensional image viewing. That is, the distance between protective glass 110 and LC panel 140 is designed so that the principal point to display surface distance “d” is equal to α′ when lens plate 120 is in contact with protective glass 110.

Any mechanism which can perform delicate adjustment of tension to the elasticity of coil springs 180a-180d accurately can be used as the mechanism for moving shafts 170a-170d. For example, shafts 170a-170d can be moved up and down by driving an electric motor or the like or by a manual operation. Further, it is also possible to stop the lens plate at a accurate position to realize a stereoscopic image viewing or a two-dimensional image viewing, by limiting movement of the lens plate by using a stopper. For example, the upper movement limitation of the lens plate may be defined by protective glass 110, as described above, and the lower movement limitation of the lens plate may be defined by providing a stopper on LC panel 140. Such a structure with the stopper provided does not necessarily require a mechanism which can perform delicate adjustment of tension accurately.

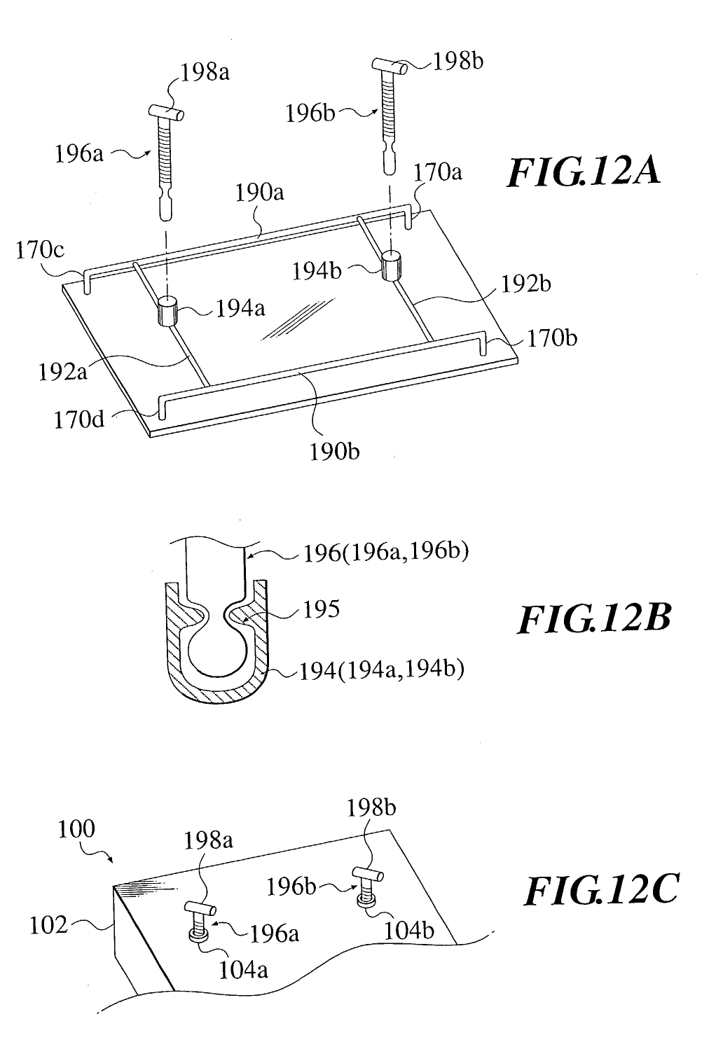

FIGS. 12A to 12C are views for explaining a structure to move the shafts by a manual operation. FIG. 12A is a perspective view of the rear side of LC panel 140. In this figure, back light 150 is omitted for simplifying. The shafts 170a and 170c are bridged by a bridging bar 190a, and the shafts 170b and 170d are bridged by a bridging bar 190b. Further, bridging bars 190a and 190b are supported to be always parallel to each other, by supporting bars 192a and 192b. On supporting bars 192a and 192b, caps 194a and 194b for supporting to hold adjusting screws 196a and 196b are mounted, respectively. On the periphery of one end side of each of adjusting screws 196a and 196b, a helical groove is formed, and on the periphery of the other end side, a ring-shaped recess is formed. On the respective one ends of adjusting screws 196a and 196b, handles 198a and 198b are attached, respectively. The other ends of adjusting screws 196a and 196b are supported in the caps 194a and 194b, respectively.

FIG. 12B is a partially sectional view of an adjusting screw 196 and a cap 194. As shown in this figure, a projecting portion 195 is formed on the inner wall of the cap 194. The adjusting screws 196 is supported with the cap 194 by the projecting portion 195 being fitted in the ring-shaped recess formed on other end of adjusting screw 196.

FIG. 12C is a perspective view of the rear side of the main body (container 102) of stereoscopic image viewing display device 100. In the embodiment, components of the stereoscopic image viewing display device 100 shown in FIG. 10 are covered by the container 102. At the positions on the rear surface of the container 102, corresponding to that of caps 194a and 194b, two holes are formed and two nuts 104a and 104b are attached to the rear surface of the container at the positions. The nuts 104a and 104b support adjusting screws 196a and 196b, respectively. That is, the shafts 170a-170d can be moved up or down by rotating the adjusting screws 196a and 196b in the clockwise or counterclockwise direction. Fine adjustment of the distance “D” between lens plate and LC panel can be performed by making the screw pitch of adjusting screws 196a and 196b and of nuts 104a and 104b sufficiently small because the forward moving length of adjusting screw 196 per a rotation becomes smaller.

Although only an embodiment in which LC panel 140 and protective glass 110 are fixed and lens plate 120 is moved, to change the distance “D” between the lens plate and the LC panel, is explained with reference to FIGS. 10 and 11, the present invention is not limited to this. For example, also a structure including a movable LC panel 130 may be used.

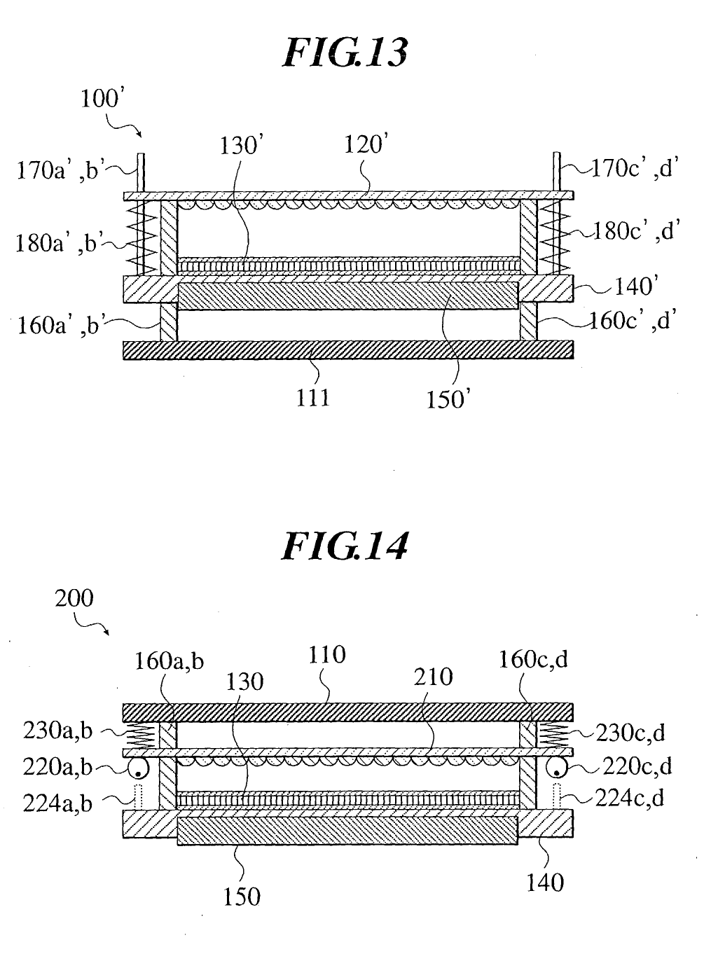

FIG. 13 is a view showing an embodiment of a type of stereoscopic image viewing display device 100′ in which a display panel 130′ is movable. The fundamental structure of stereoscopic image viewing display device 100′ is almost the same as that of stereoscopic image viewing display device 100 shown in FIG. 10. However, in stereoscopic image viewing display device 100′, supporting columns 160a′-160d′ which are arranged in parallel to one another are fixed to lens plate 120′ and supporting base 111, with passing through the fixing plate 140′. An end of each of shafts 170a′-170d′ is fixed to the fixing plate 140′. Shafts 170a′-170d′ are arranged in parallel to one another with passing through lens plate 120′, to slide in the direction parallel to supporting columns 160a′-160d′. That is, fixing plate 140′ to which display panel 130′ and back light 150′ are fixed can move in the direction parallel to supporting columns 160a′-160d′ according to the movement of shafts 170a′-170d′.

(2) Switching Mechanism 2 (Cam Type)

Next, an embodiment using a cam as a switching mechanism for switching the distance “D” between lens plate and LC panel will explained, as follows.

FIG. 14 is a schematic vertical sectional view, showing an embodiment of a stereoscopic image viewing display device 200 having a cam as a switching mechanism. The section of stereoscopic image viewing display device 200 shown in FIG. 14 is one for a position similar to that of stereoscopic image viewing display device 100 shown in FIG. 10. In this figure, stereoscopic image viewing display device 200 comprises a protective glass 110, a lens plate 210, an LC panel 130, a fixed plate 140, a back light 150, four supporting columns 160a-160d, four cam portions 220a-220d, and four coil springs 230a-230d.

Construction of protective glass 110, lens plate 210, LC panel 130, fixed plate 140, back light 150, and four supporting columns 160a-160d are almost the same as the ones as explained with reference to FIG. 10. Lens plate 210 comprises mainly a plurality of half cylindrical shaped lenses 124-1 to 124-n and a lens substrate 122, as explained with reference to FIG. 11. Lens plate 210 shown in FIG. 14 is different from lens plate 120 shown in FIG. 11 in that shafts 170a-170d and coil springs 180a-180d are not adhered thereto. Between protective glass 110 and lens plate 210, four coil springs 230a-230d are provided and fixed thereto, to perform the function of separating lens plate 210 from protective glass 110.

FIG. 15 is a view for explaining a cam portion 220. Cam portion 220 comprises mainly a cam body 221, a rotational shaft 222, and a stopper 223. Cam body 221 has an approximately cylindrical shape, and the rotational shaft 222 which extends in parallel to the peripheral surface of cam body 221 passes through cam body 221. The cam body 221 is fixed to the rotational shaft 222, to rotate according to rotation of rotational shaft 222 integrally. Rotational shaft 222 is fixed to cam body 221 eccentrically. Hereinafter, in lengths from the axis center of rotational shaft 222 to a periphery of cam body 221, the longest length is referred to as the longest radius r_{L}, and the shortest radius r_{S}. A stopper 223 is fixed to the rotational shaft 222, to rotate according to rotation of rotational shaft 222 integrally. Stopper 223 having a half ring shape is fixed to rotational shaft 222 by fixing the inner side surface of stopper 223 to the periphery of rotational shaft 222.

Four cam portions 220a-220d are disposed between lens plate 210 and fixed plate 140, and in the outside region of supporting columns 160a-160d. Cam portions 220a-220d support lens plate 210 which is compressed downward by coil springs 230a -230d . That is, cam bodies 221 are always in contact with lens plate 210, to support lens plate 210. Accordingly, the distance between lens plate 210 and LC panel 130 comes to change according to rotation of cam bodies 221.

Stopper plate 224 is fixed on fixed plate 140. Rotation of rotational shaft is limited by stopper plate 224 coming into contact with an end 223a or the other end 223b of stopper 223. Stopper 223 is fixed onto rotational shaft 222 so that when an end 223a of stopper 223 is brought into contact with stopper plate 224, the longest radius r_{L} portion of cam body 221 comes to support lens plate 210, and when the other end 223b of stopper 223 is brought into contact with stopper plate 224, the shortest radius r_{S} portion of cam body 221 comes to support lens plate 210.

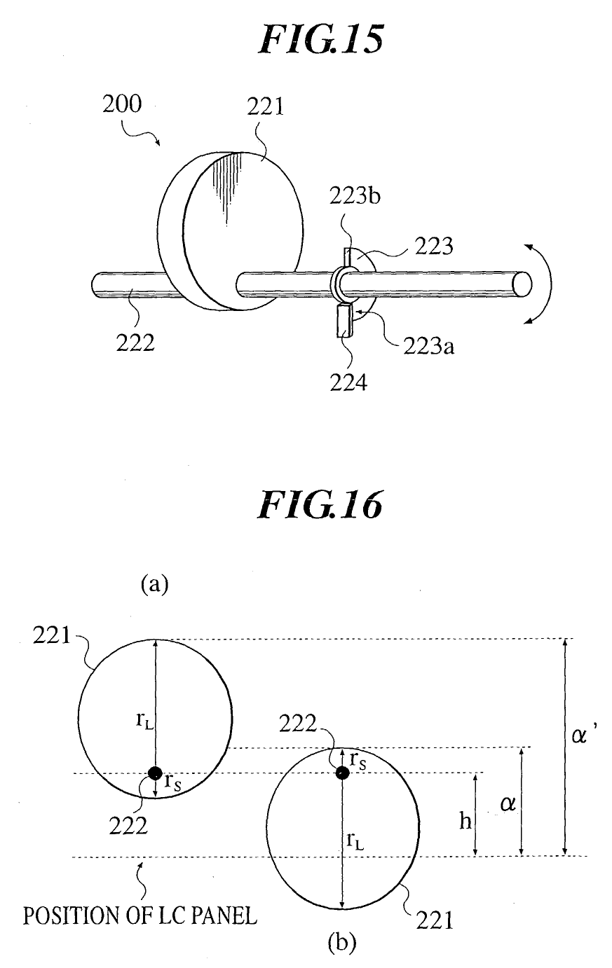

FIG. 16 is a view for explaining the relationship between the distance “D” between the lens plate and the LC panel, and the rotation of cam body 221. Here, the height of rotational shaft 222 to the position of LC panel 130 is represented by The diameter (r_{L}+r_{S}) of cam body 221, the position to fix rotational shaft 222, to cam body 221, and the height “h”, i.e., the position to set rotational shaft 222, are determined so that when the longest radius r_{L} portion of cam body 221 is brought into contact with lens plate 210, i.e., in a case of (a) in FIG. 16, the principal point to display surface distance “d” comes to be equal to α′; and when the shortest radius r_{S} portion of cam body 221 is brought into contact with lens plate 210, i.e., in a case of (b) in this figure, the principal point to display surface distance “d” comes to be equal to a According to such a structure, it is possible to easily switch from a stereoscopic image viewing to a two-dimensional image viewing or vice versa, by rotating rotational shaft 222, to change the principal point to display surface distance “d”.

As a method for rotating the rotational shaft, various types thereof can be used. For example, a mechanical method such as one using motor or the like, or method by a manual operation may be used. In the above-described embodiment, although only a cam body having an approximately circular shape is used, the shape of the cam is not limited to a circular shape. A cam having any shape, which enables taking at least two values of a (focal length) and α′ as the principal point to display surface distance according to the rotational positions, can be used.

Although movement of the distance “D” between lens plate and LC panel is performed by moving lens plate 221 by using a cam portion 220a-220d in the above-described embodiment, the present invention is not limited to this, it may be performed by moving LC panel 130. For example, in a stereoscopic image viewing display device 200, lens plate 210 may be fixed to the container of the display device 200, coil springs may be fixed between lens plate 210 and fixed plate 140 to function separating them from each other, and a cam portion may be disposed at positions to support fixed plate 140, to move fixed plate 140 to change the distance “D” by rotating the cam body.

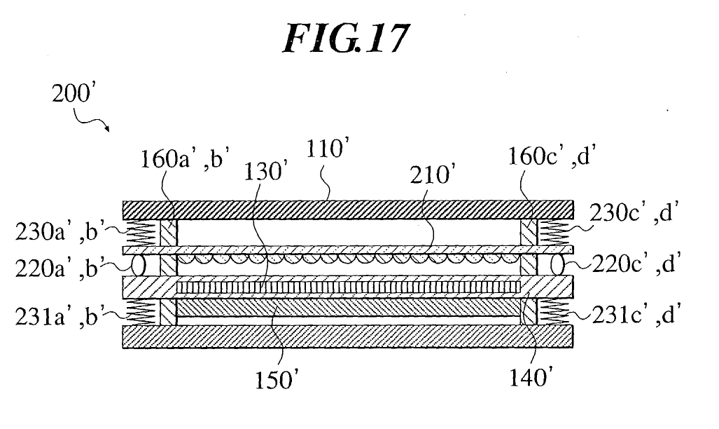

Further, also a structure to move both the lens plate and the LC panel by a cam may be used. FIG. 17 is a partially sectional view of stereoscopic image viewing display device 200′, for showing an example to have a structure to move both the lens plate 210′ and the LC panel 130′ by cam portions 220a′-220d′. The section of stereoscopic image viewing display device shown in FIG. 17 is one for a position similar to that of stereoscopic image viewing display device shown in FIG. 10. In FIG. 17, the display device comprises a structure in which lens plate 210′ and fixed plate 140′ can be moved in parallel to each other by using supporting columns 160a′-160d′ as a guide. In FIG. 17, cam portions 220a′-220d′ are disposed between lens plate 210′ and LC panel 130′, to support lens plate 210′ which is compressed downward by coil springs 230a′-230d′. Similarly, cam portions 220a′-220d′ support LC panel 130′ which is compressed upward by coil springs 231a′-231d′. Each of cam portions 220a′-220d′ comprises mainly a cam body and a rotational shaft, like the cam portion 220 explained with reference to FIG. 15. Cam body has an elliptical shape and rotates according to rotation of the rotational shaft. The minor axis and the major axis of the elliptical shape are determined so that when the elliptical cam body lies down, that is, the minor axis thereof is parallel to the supporting columns, a stereoscopic image viewing is realized, and when the elliptical cam body stands up, that is, the major axis thereof is parallel to the supporting columns, a two-dimensional image viewing is realized; and so that the distance “D” between lens plate and LC panel changes by rotating the cam body.

(3) Switching Mechanism 3 (Push-In and Pull-Out Type)

Next, an embodiment using a member having a predetermined height, to be pushed in or pulled out between lens plate and LC panel cam as a switching mechanism for switching the distance “D” between lens plate and LC panel will explained, as follows.

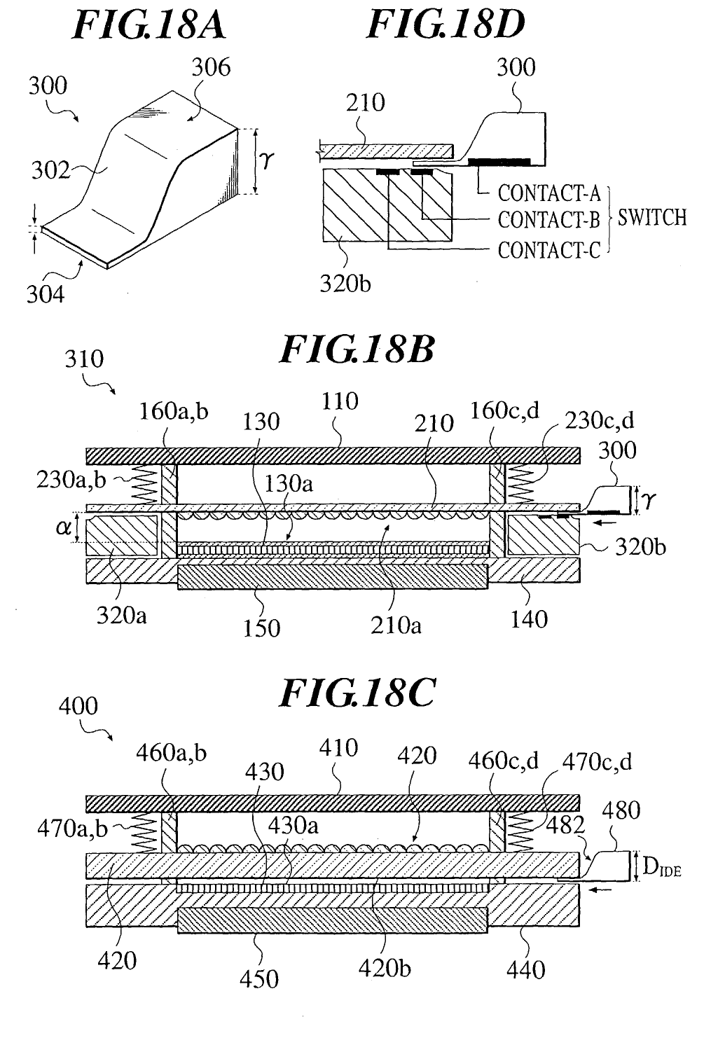

FIG. 18A is a view showing an example of insertion member 300 to be pushed between the lens plate and the LC panel (fixed plate). The insertion member 300 has a sliding surface 302 with a gentle slope. The difference of altitude γ between the thinnest portion 304 and the thickest portion 306 satisfies:

α+γ=α′

which is equal to the principal point to display surface distance in a case of two-dimensional image viewing. Therefore, it is possible to easily switch from a displaying state of stereoscopic image viewing to a displaying state of two-dimensional image viewing, by inserting insertion member 300 between the lens plate and the LC panel, to change the principal point to display surface distance “d” from α to α′. As a result, it is possible to realize a two-dimensional image viewing.

FIG. 18B is a view explaining a process of inserting the insertion member 300 shown in FIG. 18A, into a type of stereoscopic image viewing display device 310 in which the uneven surface 210a of the lens plate 210 and the displaying surface 130a of LC panel 130 are opposed to each other. As shown in FIG. 18B, supporting pedestals 320a and 320b are fixed onto fixed plate 140 in the region outside supporting columns 160a-160d. Lens plate 210 and fixed plate 140 are supported by supporting pedestals 320a and 320b so that the principal point to display surface distance “d” comes to be equal to the focal length α. Thus, a stereoscopic image viewing is realized. In order to realize a two-dimensional image viewing, the insertion member 300 is inserted between supporting pedestals 320a and 320b and the lens plate 210 from the sliding surface 302. Because the difference of altitude γ between the thinnest portion 304 and the thickest portion 306, of insertion member 300 satisfies: α+γ=α′, insertion of insertion member 300 changes the principal point to display surface distance to α′.

FIG. 18C is a view explaining a process of inserting the insertion member 480 shown in FIG. 18A, into a type of stereoscopic image viewing display device 400 in which the uneven surface 420a of the lens plate 420 is arranged in the observing side and the flat surface 420b of the lens plate 420 and displaying surface 430a of LC panel 430 are opposed to each other. The focus of each lens of the lens plate 420 is set at the position corresponding to the flat surface 420b of the lens plate 420. Therefore, a stereoscopic image viewing is realized in the state of the distance “D” between lens plate and LC panel satisfying: D=0. In order to realize a two-dimensional image viewing, the insertion member 480 is inserted between the lens plate 420 and fixed plate 440 from the sliding surface 482. Herein, the difference of altitude D_{IDE} between the thinnest portion and the thickest portion is calculated on the basis of the index of refraction “n” from lens plate into the air. Refer to the equation (1).

Thus, it is possible not only to change the principal point to display surface distance by putting a member having a predetermined height, in or out between the lens plate and the LC panel, but also to keep the distance between the lens plate and the LC panel to one for a stereoscopic image viewing or one for a two-dimensional image viewing easily. The shape of the insertion member is not limited to that of FIG. 18A, and it may be any one which can change the distance between the lens plate and the LC panel to a predetermined length and can be easily inserted between the lens plate and the LC panel (fixed plate) smoothly. Operation for inserting the insertion member between the lens plate and the LC panel may be performed mechanically or manually.

A switching mechanism may be provided between the insertion member and the supporting pedestal, for a control system for the stereoscopic image viewing display device to grasp the principal point to display surface distance or to notify the principal point to display surface distance to a casing member. Concretely, a contact sheet “A” made of electrically conductive material is provided on the lower surface of the insertion member 300, and contacts “B” and “C” which are made of electrically conductive material are provided on the upper surface of the supporting pedestal 320b. Contacts “B” and “C” are spaced apart from each other. When insertion member 300 is inserted between the lens plate and supporting pedestal 320b so that both contacts “B” and “C” are brought into contact with contact sheet “A”, contacts “B” and “C” are brought into electrically contact with each other through contact sheet “A”. A system for grasping the state of image viewing display or for outputting a notification signal to an external apparatus, on the basis of ON/OFF of the switch.

(4) Switching Mechanism 4 (Electromagnet Type)

An embodiment using electromagnets as an switching mechanism for switching the distance “D” between lens plate and LC panel will explained, as follows.

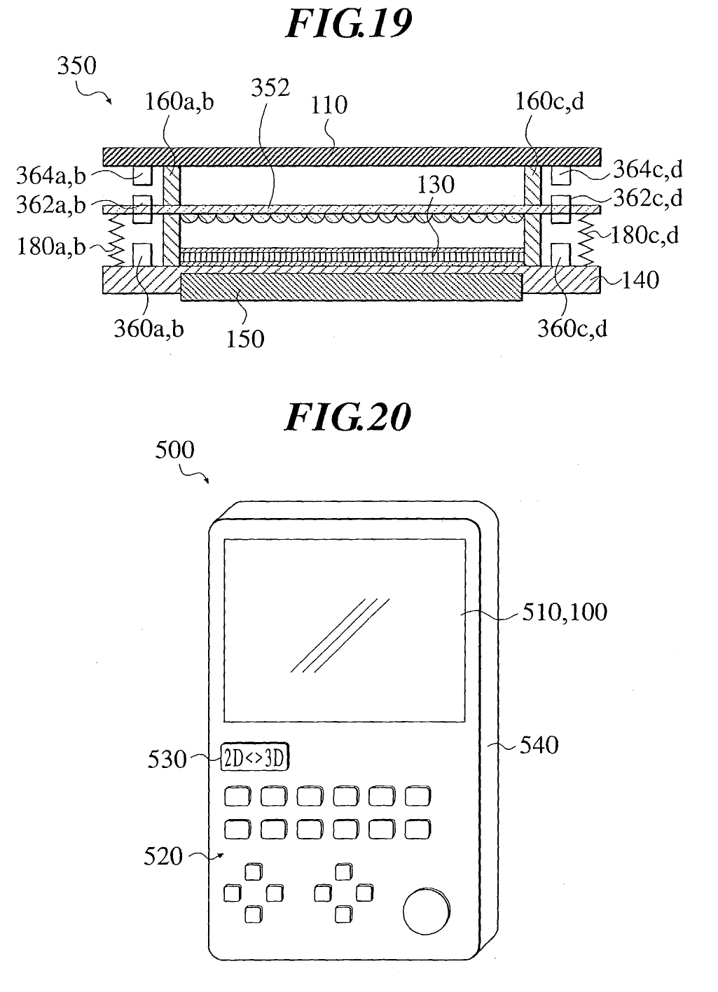

FIG. 19 is a schematic vertically sectional view, showing an embodiment of a stereoscopic image viewing display device 350 having a structure for moving lens plate 352 by using electromagnets 360a-360d. The section of stereoscopic image viewing display device shown in FIG. 19 is one for a position similar to that of stereoscopic image viewing display device 100 shown in FIG. 10. Arrangement and construction of protective glass 110, LC panel 130, fixed plate 140, back light 150, supporting columns 160a-160d, and coil springs 180a-180d are almost the same as the ones as explained with reference to FIG. 10. Lens plate 352 comprises mainly a plurality of half cylindrical shaped lenses which are mounted in the rectangular region 126, and holes 128a-128d each having a L-shaped section, formed at the positions near and outside the four corners of rectangular region 126, like lens plate 120 shown in FIG. 11. The upper ends of coil springs 180a-180d are adhered to the lens plate 352. At the four corners of lens plate 352, which are positions except in the rectangular region 126, the position of L-shaped holes 128a-128d and the position of coil springs 180a-180d, iron pieces 362a-362d are adhered to pass through lens plate 352. On fixed plate 140, electromagnets 360a-360d are adhered at respective positions which are opposed to iron pieces 362a-362d adhered to the lens plate 352, and on protective glass 110, stoppers 364a-364d are adhered at respective positions which are opposed to iron pieces 362a-362d adhered to the lens plate 352. When electric current flows in electromagnets 360a-360d, they generate magnetic fields to perform the function of attracting opposed iron pieces.

In such a structure of arrangement, in order to realize a stereoscopic image viewing, electric current is flown in electromagnets 360a-360d, to attract iron pieces 362a-362d adhered to the lens plate 352. As a result, iron pieces 362a-362d are attracted to electromagnets 360a-360d against elastic force of coil springs 180a-180d and are then brought into contact with them. Accordingly, lens plate 352 is moved toward fixed plate 140. When iron pieces 362a-362d are in contact with electromagnets 360a-360d, the principal point to display surface distance “d” comes to be equal to a to realize an appropriate state for a stereoscopic image viewing display.

On the other hand, in order to realize a two-dimensional image viewing, electric current to electromagnets 360a-360d is stopped, so that lens plate 352 is moved upward by elastic force of coil springs 180a-180d and is stopped when iron pieces 362a-362d are brought into contact with stoppers 364a-364d, respectively. When iron pieces 362a-362d are in contact with stoppers 364a-364d, the principal point to display surface distance “d” comes to be equal to α′, to realize an appropriate state for a two-dimensional image viewing display.

Method for changing the distance “D” between the lens plate and the LC panel is not limited to the above-described method. For example, a method using a piezoelectric element or the like, the shape of which changes according to applied voltage, may be also used. Although the change in shape of a piezoelectric element is minute, repetition of voltage application enables making the distance “D” to a predetermined length. As described above, the principal point to display surface distance may be changed by using a substance the shape of which changes by applying electricity, including electric voltage and electric current, heat or the like.

(5) Switching Mechanism 5 (Slide Type)

An embodiment using lens plate which is slid along a cam surface as an switching mechanism for switching the distance “D” between lens plate and LC panel will explained, as follows.

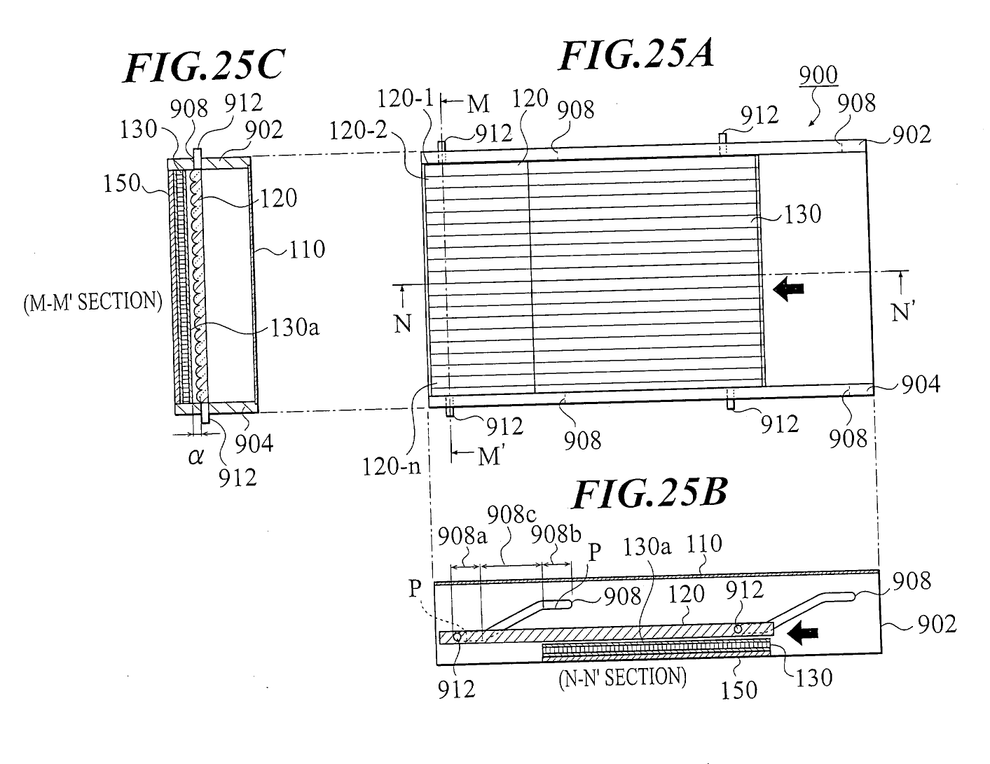

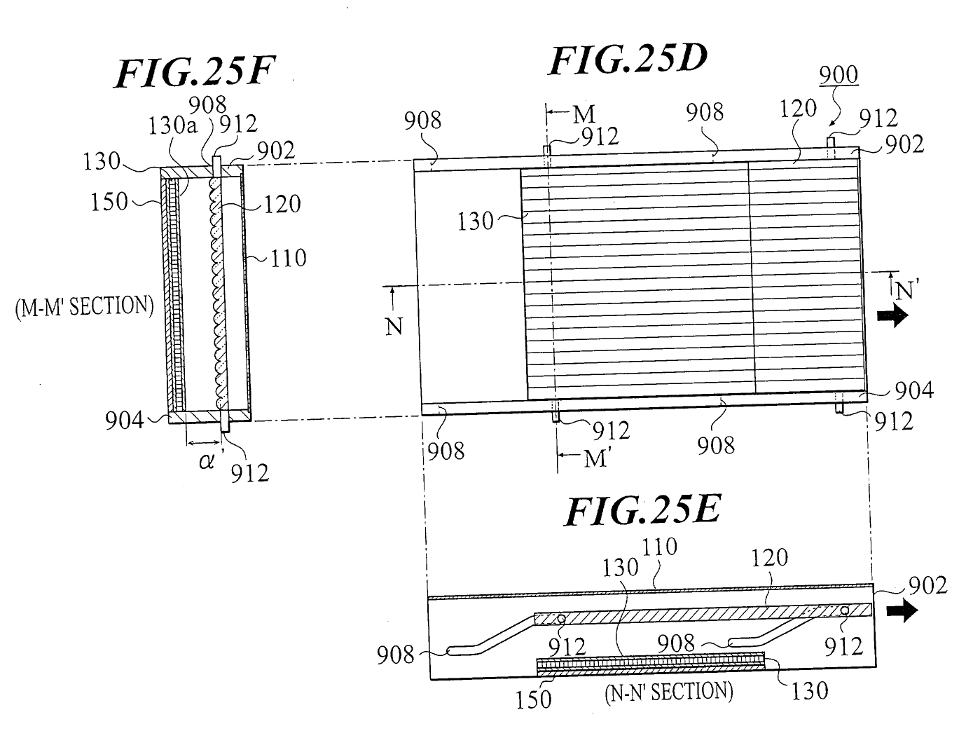

FIGS. 25A-25F show an embodiment of stereoscopic image viewing display device 900 having such an switching mechanism, in a stereoscopic image viewing, in which FIGS. 25A, 25B, and 25C are a schematically plan view, a schematically vertically sectional front view, and a schematically vertically sectional side view, thereof, respectively; and FIGS. 25D-25F show the embodiment of stereoscopic image viewing display device 900, in a two-dimensional image viewing, in which FIGS. 25D, 25E, and 25F are a schematically plan view, a schematically vertically sectional front view, and a schematically vertically sectional side view, thereof, respectively.

Construction of protective glass 110, lens plate 120, LC panel 130, and back light 150 are almost the same as the ones as explained with reference to FIG. 10.

As shown in FIGS. 25A-25F, cam plates 902 and 904 are provided to sandwich protective glass 110, lens plate 120, LC panel 130, and back light 150, therebetween. Each of cam plates 902 and 904 has an elongated rectangular plate shape which extends in the longitudinal direction of LC panel 130 and is stood in a direction almost perpendicular to LC panel 130. LC panel 130 and back light 150 are fixed to cam plates 902 and 904. That is, LC panel 130, back light 150, and cam plates 902 and 904 form an approximately U-shaped section, having an opening portion in the displaying surface side, and the opening portion is covered with protective glass 110, to protect the inside thereof.

Lens plate 120 is arranged in the interior of the approximately U-shaped section, in parallel to LC panel 130 so that the direction of cylindrical axis of each half cylindrical shaped lens 124-1 to 124-n is parallel to the longitudinal direction of cam plates 902 and 904. On both side surfaces of lens plate 120, sliders (contact elements) 912 and 912 are attached. The sliders 912 and 912 are inserted in long cam holes 908 which are formed in cam plates 902 and 904 to have a predetermined figure, so that lens plate 120 can slide along the figure of long cam holes 908 with an approximate constant width. Although sliders 912 and 912 are formed integrally as a cylindrical portion of lens plate 120, sliders 912 do not necessarily have such a shape nor are necessarily formed integrally. As each slider 912, a separated roller or the like may be also attached to each side surface of lens plate 120.

Each long cam hole 908 has horizontal portions 908a and 908b having surfaces “P” parallel to the displaying surface 130a of LC panel 130, and a slope portion 908c for connecting the horizontal portions 908a and 908b. The horizontal portions 908a and 908b are different from each other in distance from the displaying surface 130a and position on the horizontal surface “P”. In FIGS. 25A-25F, horizontal portions 908a and 908b are set so that when sliders 912 are at positions on the lower horizontal portions 908a, the principal point to display surface distance “d” comes to be equal to α, which is the distance appropriate for a stereoscopic image -viewing display, and when sliders 912 are at positions on the upper horizontal portions 908b, the principal point to display surface distance “d” comes to be equal to α′, which is the distance appropriate for a two-dimensional image viewing display. When sliders 912 are at positions on the horizontal portions 908a or 908b, sliders 912 do not move from the positions unless a sliding operation performed.

Therefore, when sliding lens plate 120 toward the lower horizontal portion 908a, i.e., in the left direction, lens plate 120 comes to be at a position for a stereoscopic image viewing display, as shown in FIGS. 25A or 25B, and when sliding lens plate 120 toward the upper horizontal portion 908b, i.e., in the right direction, lens plate 120 comes to be at a position for a two-dimensional image viewing display, as shown in FIGS. 25D or 25E. Horizontal portions 908a and 908b which have surfaces “P” with a length parallel to the displaying surface 130a, enable fine adjustment for the position of lens plate 120 with respect to LC panel 130.

In the switching mechanism of the embodiment, it is required that lens plate 120 covers the displaying surface 130a of LC panel 130 in any state of stereoscopic and two-dimensional image viewing displays. Therefore, the length of lens plate 120 in the direction of axes of half cylindrical shaped lenses 124-1 to 124-n is set to be longer than that of LC panel 130, as shown in FIGS. 25A-25F.

Sliding operation for lens plate 120 may be performed manually, for example, by driving a handle provided at right or left end of lens plate 120, manually, or may be performed by driving a motor or the like.

In the latter case, for example, a biasing member, e.g., a spring or the like, may be provided on one of right and left end surfaces of lens plate 120 in FIG. 25A, for giving a biasing force to the lens plate toward the other end, and a rotary cam which is controlled by a motor may be provided on the other of the right and left end surfaces. That is, lens plate 120 may be biased to be always contact with the rotary cam. According to such a construction, it is possible to adjust the slide amount of lens plate 120 by controlling rotation of the rotary cam.

Horizontal portion 908a or 908b may be provided with a fitted portion in which slider 912 is fitted. In such a structure, when sliding lens plate 120, to fit slider 912 into the fitted portion of horizontal portion 908a or 908b, or to take slider 912 out of the fitted portion, a fitting resistance or a removing resistance can be generated to give an operational feeling to inform movement of the slider clearly, i.e., feeling of click. It also enables preventing slider 912 from slipping out of horizontal portion 908a or 908b.

Although cam plates 902 and 904 are fixed and lens plate 120 is moved in the embodiment shown in FIGS. 25A-25F, the relationship between them may be reverse. For example, lens plate 120 may be movable in only vertical direction with respect to LC panel 130, like the case of FIG. 10, and cam plates 902 and 904 may be slidable in the longitudinal direction with respect to LC panel 130, i.e., in right and left direction in FIGS. 25A and 25D. The cam plates 902 and 904 may be slidable integrally by manual operation or by driving another reciprocal moving mechanism. Further, another construction in which cam plates 902 and 904 are slidable in a direction and lens plate 120 is slidable in a reverse direction, is also adopted.

(6) Switching Mechanism 6 (Rotation Type)

An embodiment using a lens plate rotated as an switching mechanism for switching the distance “D” between lens plate and LC panel (Distance changing means) will be explained, as follows.

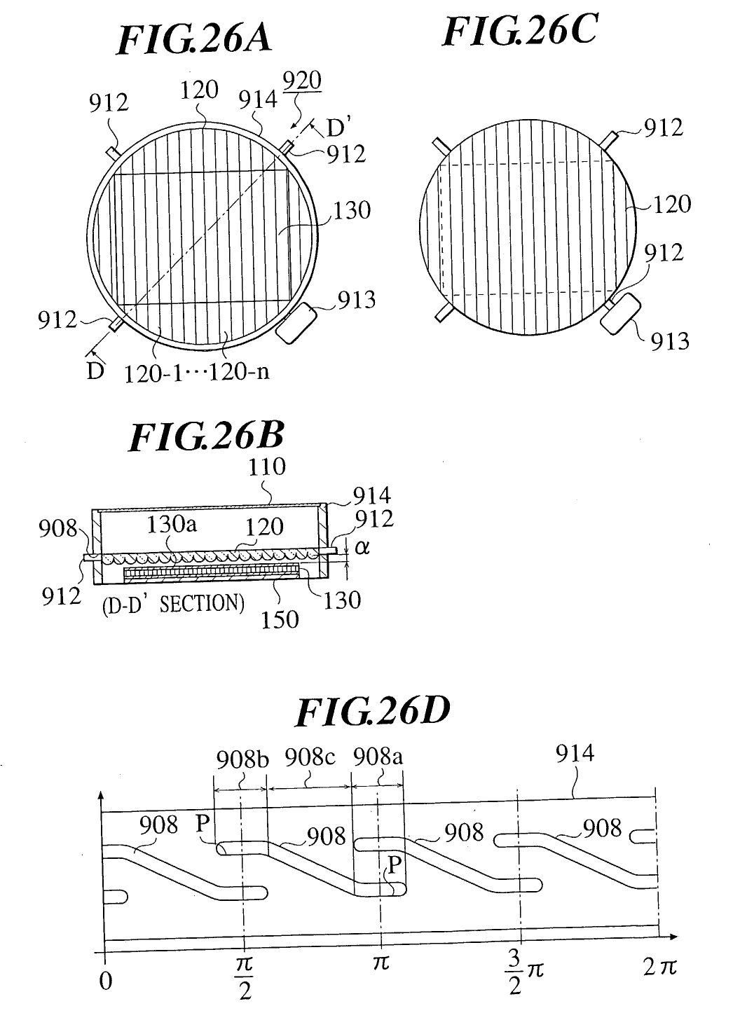

FIGS. 26A and 26B are a schematic plan front view and a schematically vertically sectional view which show an embodiment of stereoscopic image viewing display device 920 having a switching mechanism. In the switching mechanism, an integral ring-shaped cam ring 914 is used instead of the above-described cam plates 902 and 904. That is, LC panel 130, and back light 150 are disposed at the center inside cam ring 914. Construction of protective glass 110, lens plate 120, LC panel 130, and back light 150 are almost the same as the ones as explained with reference to FIG. 10.

As shown in FIG. 26C, lens plate 120 has sliders 912 at the periphery thereof. The sliders 912 are passed through cam holes 908 which are formed in the side surface of cam ring 914 so that lens plate 120 is movable along the inner surface of cam ring 914, in parallel to LC panel 130. A plurality of half cylindrical shaped lenses are formed on the entire surface of lens plate 120 in the embodiment, they may be formed only in the area corresponding to LC panel 130, i.e., the area shown by the dotted line in FIG. 26C, on lens plate 120.

FIG. 26D is an exploded side view which show an example of the cam ring in the switching mechanism when viewing from the outside. The lower side in this figure is in the direction of LC panel 130. For example, each cam hole 908 is formed so that the phase difference between horizontal portions 908a and 908b is occurred by an approximate angle of 90°. Thus, when switching, it is possible to depress flicker on an image which may be caused by a difference between the horizontal or vertical direction of the dot matrix of LC panel 130 and the direction of each half cylindrical shaped lens 124-1 to 124-n, by coinciding one of the horizontal and vertical directions of the dot matrix with the direction of each lens. In this figure, horizontal portions 908a and 908b are set so that when sliders 912 are at positions on the lower horizontal portions 908a, the principal point to display surface distance “d” comes to be equal to α, and when sliders 912 are at positions on the upper horizontal portions 908b, the principal point to display surface distance “d” comes to be equal to α′.

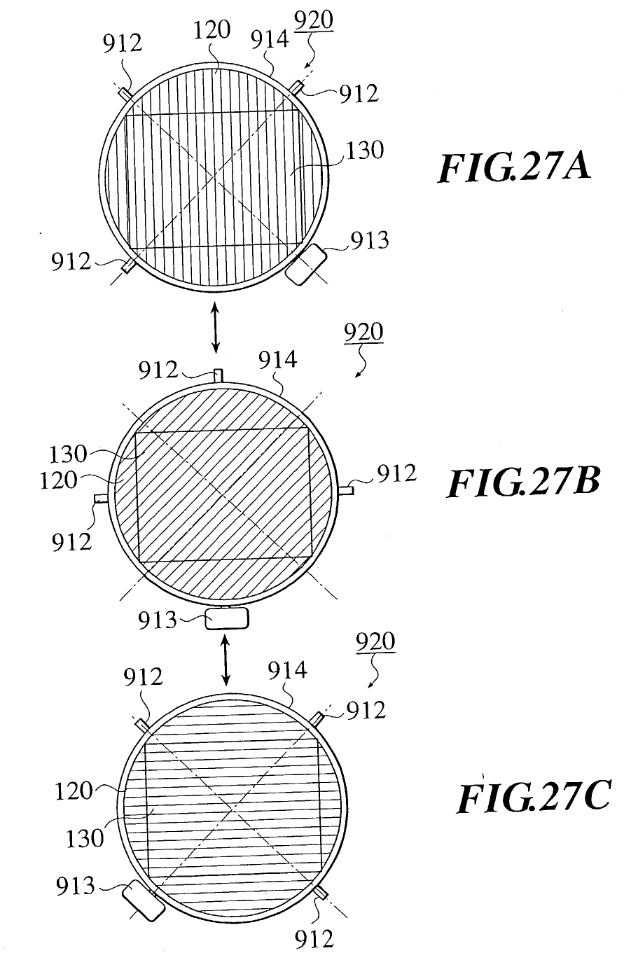

FIGS. 27A-27C are plan views showing successive states of the switching mechanism, for explaining an operation manner thereof. FIG. 27A shows a state for stereoscopic image viewing and FIG. 27C shows a state of two-dimensional image viewing. In order to switch from a stereoscopic viewing display to a two-dimensional viewing display, sliders 912 are rotated in a clockwise direction in the figures, up to reaching horizontal portions 908b, as shown in FIGS. 27A, 27B and 27C in the order thereof, to move the lens plate 120 to a position for a two-dimensional image viewing display. On the contrary, in order to switch from a two-dimensional viewing display to a stereoscopic viewing display, sliders 912 are rotated in a counterclockwise direction, up to reaching horizontal portions 908a, as shown in FIGS. 27c, 27B and 27A in the order thereof, to move the lens plate 120 to a position for a stereoscopic image viewing display. Thus, it is possible to switch a stereoscopic viewing display to a two-dimensional viewing display and vice versa.

Operation for rotating lens plate 120 may be performed manually, for example, by using a handle 913 which is attached to the end of one of sliders 912. Operation for rotating lens plate may be also performed by driving a ring-shaped ultrasonic motor or the like, which is provided on the inner or outer surface of cam ring 914 and is connected to sliders 912.

Although cam ring 914 is fixed and lens plate 120 is moved in the embodiment shown in FIGS. 26A-26D and 27A-27C, the relationship between them may be reverse. For example, lens plate 120 may be movable in only vertical direction with respect to LC panel 130, by using shafts or the like, like the case of FIG. 10, and cam ring 914 may be rotatable with respect to LC panel 130. Thus, cam ring 914 can be rotated integrally manually or by using a motor. Further, another construction in which cam plates 902 and 904 are slidable in a direction and lens plate 120 is slidable in a reverse direction, is also adopted.

In a stereoscopic image viewing display, rotational angle of lens plate 120 is required to be very precise with respect to the dot matrix of LC panel 130. Rotational angle of lens plate 120 can be controlled by using the end (left end of cam hole 908 in FIG. 26D) of horizontal portions 908a for stereoscopic image viewing display, of cam hole 908, for positioning. However, repeated switching operations may occur a shift of the position. In order to solve the problem, the end of horizontal portions 908a may be set at a position at which lens plate 120 can be rotated an angle a little larger than the afore-described predetermined angle, to make the range of horizontal portions 908a wider. Preferably, appropriate rotation of lens plate 120 within the range of horizontal portions 908a enables fine adjustment of the angle with respect to the dot matrix LC panel 130.

Further, it is preferable to provide a construction for storing the result of fine adjustment.

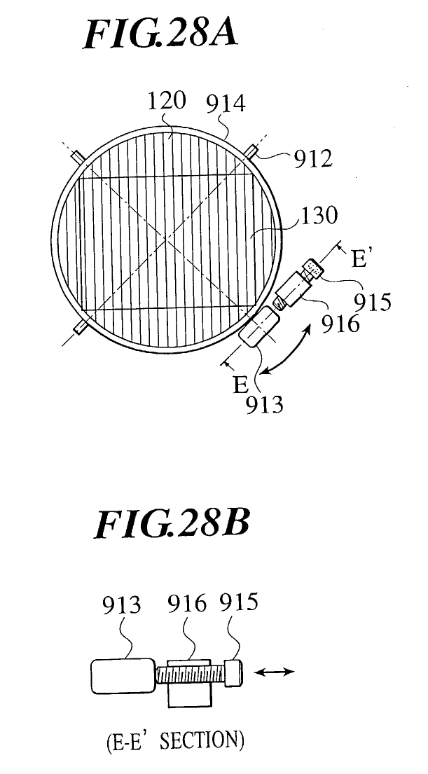

FIGS. 28A and 28B show an embodiment of the switching mechanism 6 having a mechanism for fine adjustment. A mounted screw reception 916 is provided with male screw 915 for fine adjustment, as shown in FIG. 28A. Male screw 915 is moved in the direction shown by an arrow in FIG. 28B by rotating itself with respect to male screw 915. Male screw 915 functions as a stopper for controlling movement of handle 913. Accordingly, it is possible to control rotation of lens plate 120 and to keep the optimum rotational angle for a stereoscopic image viewing display.

Next, an example of small-sized electronic apparatus using the invention will be explained, as follows. Here, a small-sized electronic apparatus having a stereoscopic image display device which is provided with a switching mechanism for switching the distance “D” between lens plate and LC panel will be explained, as follows. Although only an example of stereoscopic image display device 100 with Switching Mechanism 1 (Shaft Type) which is explained with reference to FIGS. 10 and 11, will be explained, the present invention is not limited to this.

FIG. 20 is a perspective view showing an embodiment of container 540 of a small-sized electronic apparatus 500.

In this figure, on container 540 of a display screen 510, at least a display screen 510 and a group of a plurality of input keys 520 for users to perform input operation are provided. A user can input a predetermined instruction by pressing down an appropriate key among the group of input keys 520, and see an image displayed on display screen 510. Small-sized electronic apparatus 500 have a switching key 530 to which a user inputs an instruction for switching between a stereoscopic viewing display and a two-dimensional viewing display.

Display screen 510 comprises a stereoscopic image display device 100 with switching mechanism 1 (Shaft Type) for switching the distance “D” between lens plate and LC panel, which is shown in FIG. 10. That is, display screen 510 of small-sized electronic apparatus 500 shown in FIG. 20 corresponds to protective glass 110 in stereoscopic image display device 100. A user can see an image displayed on LC display 130 through protective glass 110 and lens plate 120.

In stereoscopic image display device 100, switching operation between stereoscopic and two-dimensional viewing displays is carried out by moving shafts 170a-170d by the power obtained from a driving system of electronic apparatus 500, and an image is displayed on LC panel 130 on the basis of image data input from a control system of electronic apparatus 500. That is, when an input of switching key 530 is performed by a user, shafts 170a-170d of stereoscopic image display device 100 are moved by the driving system, to perform a switch operation between stereoscopic and two-dimensional viewing displays. Accompanying with the switch operation, the image data are also switched from one for a stereoscopic viewing to one for a two-dimensional viewing or vice versa and thereby an image thereof is displayed on LC panel 130.

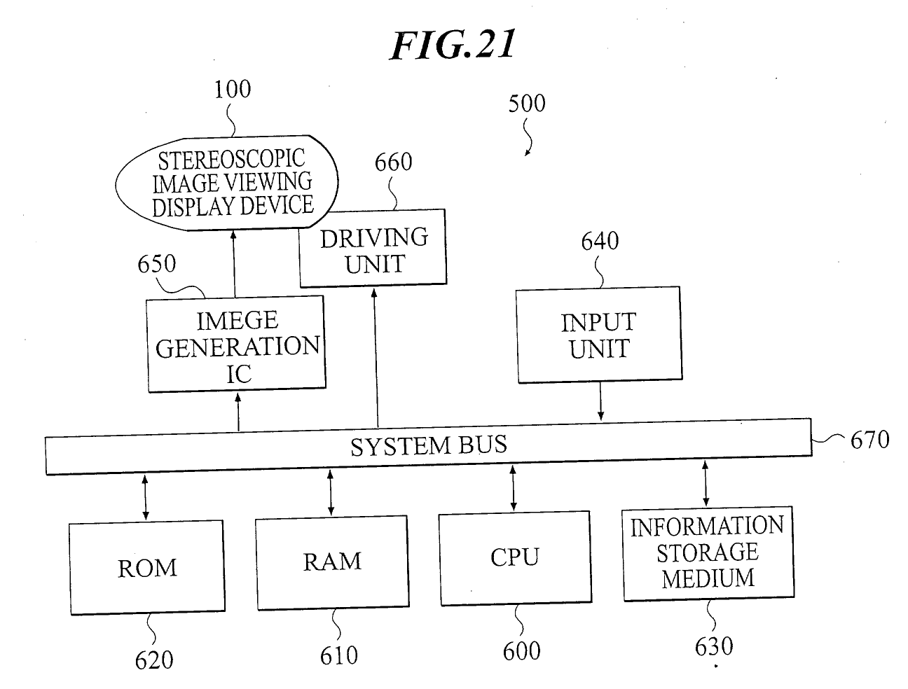

FIG. 21 shows an embodiment of hardware construction of small-sized electronic apparatus 500 shown in FIG. 20. In this figure, electronic apparatus 500 comprises a CPU 600, a RAM 610, a ROM 620, an information storage medium 630, an input unit 640, an image generation IC 650, and a driving unit 660, which are mutually connected to one another through a system bus 670, to input and output data. To image generation IC 650, stereoscopic image display device 100 is connected.

CPU 600 performs control of whole the apparatus, various types of data processing, switching processing which will be described later, and the like, on the basis of program or data which are stored in ROM 620 or information storage medium 630. RAM 610 is a storage which is used as a working area for CPU 600, for temporarily storing, for example, information input from input unit 640, operation results by CPU 600, program or data which were read out from information storage medium 630 by CPU 600, and the like. Image information prepared by CPU 600 is also stored to RAM 610.

ROM 620 stores information necessary to start up or operate small-sized electronic apparatus 500, e.g., a system program: initialization information, information for controlling data transmission between devices or units which are connected through system-bus 670, and the like. Information storage medium 630 stores various types of image data to display on stereoscopic image display device 100, information (program data) for CPU 600 to control driving unit 660, information for outputting an instruction to make image generation IC 650 produce image data, information for image generation IC 650 to produce image data for a stereoscopic viewing and for a two-dimensional viewing, and the like. Information storage medium 630 is realized by a hardware such as an IC card, a memory, a hard disc, or the like.

Input unit 640 is a device for detecting an input pressed down by a user and outputting an identifying signal which is attached to the pressed down key, to CPU 600. Input unit 640 includes the group of input keys 520 and a switching key 530.

Image generation IC 650 is one for producing image data to be output to stereoscopic image display device 100, on the basis of image information stored in RAM 610, ROM 620, information storage medium 630 or the like. Stereoscopic image display device 100 controls outputs of each pixel of LC panel 130 shown in FIG. 10, on the basis of image data input from image generation IC 650. Driving unit 660 is a device for adjusting the force to pull shafts 170a-170d of stereoscopic image display device 100 shown in FIG. 10 according to an instruction input from CPU 600, to change the distance “D” between the lens plate and the LC panel.

Driving unit 660 comprises, for example, a motor, a wheel and the like.

Function of small-sized electronic apparatus 500 will be described, as follows.

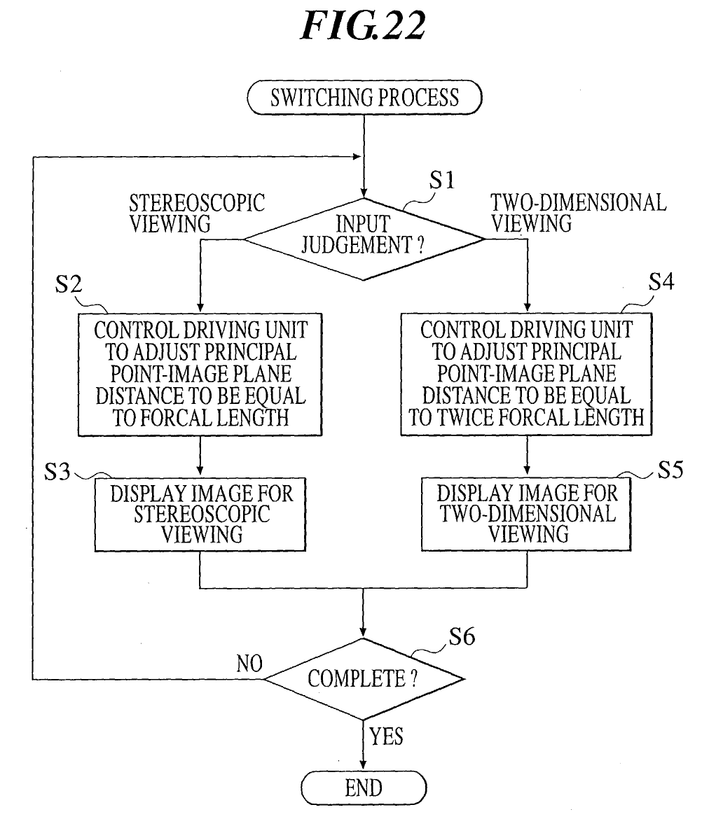

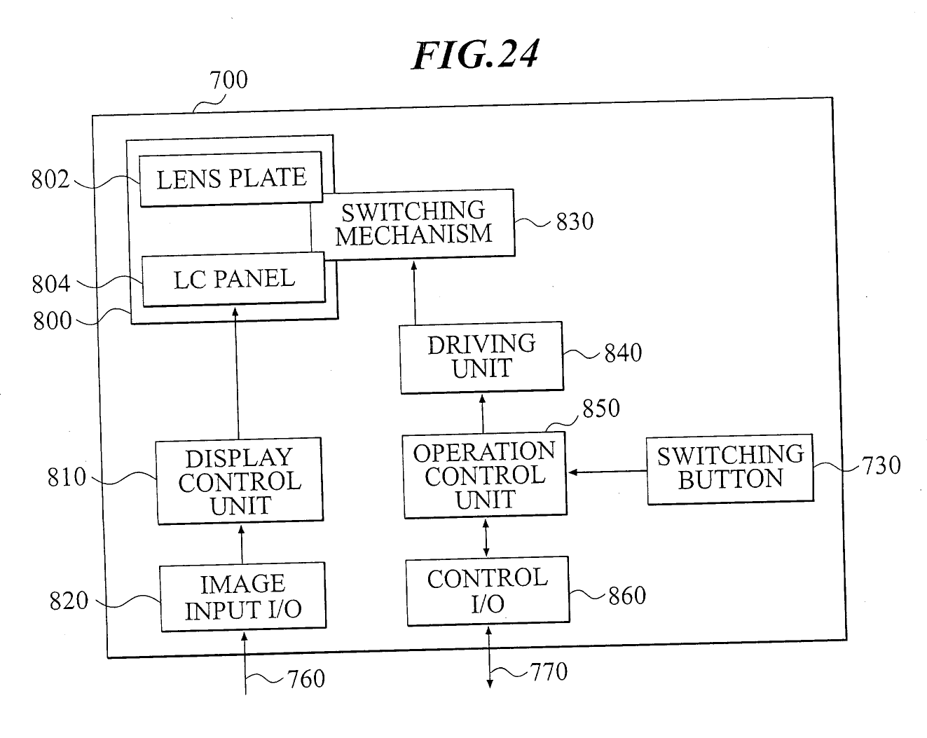

FIG. 22 is a flow chart for explaining a switching process according to the electronic apparatus 500.

First, CPU 600 judges whether a signal input from input unit 640 is one according to switching key 530 pressed down in step S1.

When a judgment for realization of stereoscopic viewing is performed in step S1, CPU 600 outputs an instruction to realize stereoscopic viewing to driving unit 660. When driving unit 660 receives the instruction to realize stereoscopic viewing from CPU 600, the driving unit pulls shafts 170a-170d against the repulsive force of coil springs 180a-180d, to make the distance “D” between lens plate and LC panel to be equal to one for stereoscopic viewing in step S2. CPU 600 gives an instruction to produce image data for a stereoscopic viewing to image generation IC 650. Image generation IC 650 produces image data for a stereoscopic viewing according to the instruction of CPU 600 and outputs the image data to stereoscopic image display device 100 to display the image, in step S3.

Herein, image data for a stereoscopic viewing is a combination of images regarding viewing directions depending on the position relationship between each pixel of LC panel 130 and each lens of lens plate 120. That is, image generation IC 650 produces image data for displaying an image information corresponding to each viewing direction, on each pixel, to output them to stereoscopic image display device 100. Stereoscopic image display device 100 makes LC panel 130 display an image on the basis of image data input from image generation IC 650.

When a judgment for realization of two-dimensional viewing is performed in step S1, CPU 600 outputs an instruction to realize two-dimensional viewing to driving unit 660. When driving unit 660 receives the instruction to realize two-dimensional viewing from CPU 600, the driving unit reduces the force pulling shafts 170a-170d, i.e., the force acting against the repulsive force of coil springs 180a-180d, to make the distance “D” between lens plate and LC panel to be equal to one for two-dimensional viewing in step S4. CPU 600 gives an instruction to produce image data for a two-dimensional viewing to image generation IC 650. Image generation IC 650 produces image data for a two-dimensional viewing according to the instruction of CPU 600 and outputs the image data to stereoscopic image display device 100 to display the image, in step S5.

Herein, image data for a two-dimensional viewing is a data to realize a two-dimensional viewing with no parallax such as a general video image. However, when a precise image or the like, such as a character with pixels each of which has a different display state to one another, is displayed on LC panel 130, it is preferable to replace the image information to be displayed on pixels or color elements, as explained with reference to FIGS. 5 and 6. That is, image generation IC 650 determines whether replacing the image information is performed, as occasion demands, for the image data to output to stereoscopic image display device 100. For example, when displaying a rough image, image data for a two-dimensional viewing is given to stereoscopic image display device 100, as it is, and when displaying a precise image, an image data to which replacing the image information was performed is given to stereoscopic image display device 100. Yes or no of the replacement of image information may be performed on the basis of an input instruction of a user and also on the basis of a program or data. Stereoscopic image display device 100 makes LC panel 130 display an image on the basis of image data input from image generation IC 650.

When stereoscopic image display device 100 makes LC panel 130 display an image, in step S3 or S5, CPU 600 judges whether the display of the image is to be finished, in step 6. When an instruction for switching the image display is input from the input unit 640 or the like, at this time, the above process is repeated from step SI. When an instruction for finishing the image display, i.e., an instruction for turning the power off, is input from the input unit 640, the process is completed.

As described above, automatic switching between a stereoscopic viewing display and a two-dimensional viewing display in response to the input by a user, enables improvement of convenience of stereoscopic image display device and also image displaying according to various embodiments. The electronic apparatus having a stereoscopic image display device, according to the invention is not limited to the small-sized electronic apparatus shown in FIG. 20, and can also apply for a car navigation apparatus, a small-sized game apparatus for domestic or business use, an electronic note, an electronic computer, an electronic dictionary, or the like.

In use of a small-sized electronic apparatus 500, as shown in FIGS. 20 and 21, as a game apparatus, the game may be constructed to perform switching between a stereoscopic viewing display and a two-dimensional viewing display, every stage. In this case, CPU 600 judges whether the display is for a stereoscopic viewing or for a two-dimensional viewing, every switching of game stage. To realize stereoscopic, CPU 600 gives an instruction to increase the force pulling shafts 170a-170d, to driving unit 660, and to realize a two-dimensional viewing, CPU 600 gives an instruction to decrease the force pulling shafts 170a-170d, to driving unit 660, to change the distance between lens plate and LC panel appropriately. Changing the distance between lens plate and LC panel may be also carried out on the basis of a code attached to image data, a program or the like, a processing state according to a predetermined program, a timing table or the like.

The stereoscopic image display device described with reference to FIGS. 1-19 and 25-27 can be applied not only for the small-sized electronic apparatus 500 shown in FIGS. 20 and 21. It is a matter of course that the stereoscopic image display device can be used itself independently. For example, it may be used as a display to be connected a personal computer (PC). In this case, the body of stereoscopic image display device may have a driving unit for driving the switching mechanism for switching the distance “D” between lens plate and LC panel within, to change the distance “D” in response to the input by a user.

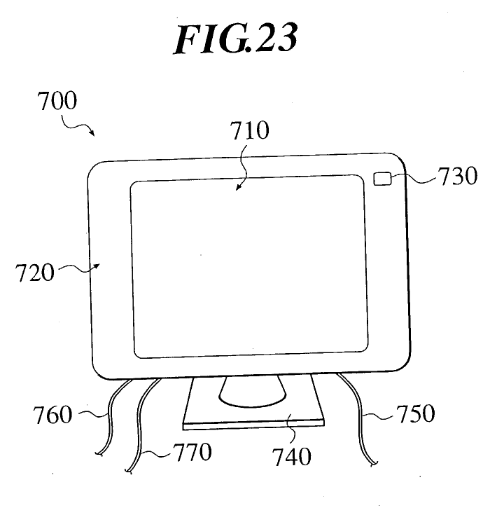

FIG. 23 shows an embodiment of stereoscopic image display device 700 having a driving unit for driving the switching mechanism. The stereoscopic image display device 700 comprises a display screen 710, an outer frame 720, a pedestal 740, and a switching button 730. The switching button 730 is arranged on outer frame 720. When a user presses down the switching button, the built-in driving unit drives the switching mechanism, e.g., a shaft type of switching mechanism 1 shown in FIG. 10, a cam type of switching mechanism 2 shown in FIG. 14, a push-in and pull-out type of switching mechanism 3 shown in FIG. 18, an electromagnet type of switching mechanism 4 shown in FIG. 19, a slide type of switching mechanism 5 shown in FIG. 25, a rotation type of switching mechanism 6 shown in FIG. 26, or the like, to change the distance “D” between lens plate and LC panel.

Stereoscopic image display device 700 shown in FIG. 23 comprises a power supply connector (not shown) for connecting the display device to the power supply through a cable 750. That is, stereoscopic image display device 700 works by electric power supplied from the power supply through a cable 750. The display device comprises a connector (not shown) for connecting the display device to an external device such as a PC and the like, through a cable 760. That is, stereoscopic image display device 700 makes the LC panel display an image according to image data input from the external device through a cable 760. Further, display device 700 comprises a cable 770 for outputting an external device a signal which informs of switching button 730 pressed down and for receiving a signal for operation of driving unit 840 from the external device.

FIG. 24 shows an embodiment of hardware construction of stereoscopic image display device 700 shown in FIG. 23. The display device 700 comprises a display unit 800 which includes a lens plate 802 and an LC panel 804, a display control unit 810 for controlling the display operation of LC panel 804, an image input I/O 820 connected to an external device, a switching mechanism 830 for switching the distance “D” between lens plate and LC panel, a driving unit 840 for driving switching mechanism 830, an operation control unit 850 for controlling driving unit 840, a control I/O 860 connected to an external device, and a switching button 730.

Display control unit 810 controls the display operation of LC panel 804 on the basis of image data input from the external device through image input I/O 820.

Driving unit 840 drives switching mechanism 830 according to an instruction which is input from operation control unit 850. For example, in case of using a shaft type shown in FIG. 10 or a push-in and pull-out type shown in FIG. 18, as a switching mechanism, driving unit 840 can be realized by shafts 170a-170d, cam portions 220a-220d, a motor for driving the insertion member 300, a wheel and the like. In case of using an electromagnet type of switching mechanism shown in FIG. 19, electromagnets 360a-360d functions as the driving unit 840.

Operation control unit 850 is a device for controlling the operation of driving unit 840. For example, in case of using a shaft type of switching mechanism 1, control unit 850 gives an instruction about amount and direction of rotation of a motor for driving shafts 170a-170d ; in case of using a cam type of switching mechanism 2, control unit 850 gives an instruction for driving a motor to operate cam portions 220a-220d; and in case of using a push-in and pull-out type of switching mechanism 3, control unit 850 gives an instruction for driving a motor to insert the insertion member 300. In case of using an electromagnet type of switching mechanism shown in FIG. 19, control unit 850 determines whether electric current should be supplied to electromagnets 360a-360d.

Operation control unit 850 makes driving unit 840 work in response to a signal input from switching button 730 and generates a notification signal for notifying an external device of which stereoscopic image display device 700 is in a stereoscopic viewing display state or in a two-dimensional viewing display state and outputs it. Operation control unit 850 generates a notification signal according to the operating state of driving unit 840 and outputs it to the external device through control I/O 860. For example, in case of driving the switching mechanism by a motor, control unit 850 generates a notification signal corresponding to the amount of rotation and the presence or absence of rotation of a motor; and in case of using switching mechanism 4, control unit 850 generates a notification signal by presence or absence of supplying electric current to electromagnets 360a-360d. In case of adopting the switching mechanism with a switch shown in FIG. 18D, a notification signal may be generated on the basis of the state of ON/OFF of the switch. As described above, an instruction to switch the types of image viewing, i.e., a stereoscopic viewing or a two-dimensional viewing, is output to the external device according to the distance between lens plate and LC panel, i.e., according to the operating state of driving unit 840.

Stereoscopic image display device 700 switches the display states between a stereoscopic viewing display state and a two-dimensional viewing display state, not only in response to an input of switching button 730 but also in response to an instruction input from an external device connected. That is, operation control unit 850 makes driving unit 840 work in response to a signal input from the connected external device through control I/O 860. According to such a construction, it is possible to switch the display states between a stereoscopic viewing display state and a two-dimensional viewing display state by making the driving unit 840 work, i.e., by driving switching mechanism 830, in response to an instruction input from an external device.

Switching mechanism of stereoscopic image display device 700, as shown in FIG. 23, is not limited to one in which switching is performed by a driving unit mechanically, and it may be a type of the distance between lens plate and LC panel changed by a manual operation. In case of a manual operation, when switching the distance between lens plate and LC panel or when starting up the stereoscopic image display device, a notification signal for notifying of which the display device is in a stereoscopic viewing display state or in a two-dimensional viewing display state may be output to the external device. For example, in case of using a push-in and pull-out type of switching mechanism and switching the displaying states manually, as shown in FIG. 18D, a notification signal may be generated by turning the state of the switch on, with sliding the insertion member 300 and may be output to the external device.

The electronic apparatus, i.e., the external device, which is connected to stereoscopic image display device 700 shown in FIG. 23 and which outputs image data comprises at least a CPU, a RAM, a ROM, an information storage medium, an input unit, an image generation IC, and a connector for connecting stereoscopic image display device 700 thereto, like the hardware construction of the small-sized electronic apparatus 500. Image generation IC produces image data according to an instruction input from the CPU to output them to stereoscopic image display device 700 through the connector.

When producing image data, the electronic apparatus switches the states between for a stereoscopic viewing and for a two-dimensional viewing, in response to a notification signal from stereoscopic image display device 700, and produces image data. That is, CPU judges whether it should be a stereoscopic viewing or a two-dimensional viewing according to a notification signal from stereoscopic image display device 700 and makes the image generation IC produce the image data on the basis of the judged result. For example, when CPU performs judgment to realize a two-dimensional viewing, the image generation IC produces image data for a two-dimensional viewing.

The electronic apparatus which is connected to stereoscopic image display device 700 may output an instruction to change the distance between lens plate and LC panel, to stereoscopic image display device 700 when sending the image data. Changing the distance between lens plate and LC panel may be carried out in response to a user's input, on the basis of data or a program stored in a ROM or an information storage medium, or according to a processed result based on a predetermined program or a signal input from an input unit.

The electronic apparatus which is connected to stereoscopic image display device 700 may be one which performs an action only for outputting image data to stereoscopic image display device 700. For example, the electronic apparatus may have two types of image data of one for a stereoscopic viewing and one for a two-dimensional viewing, to switch the types of image data to be output, in response to a signal input from stereoscopic image display device 700.

In the above-described explanation with reference to FIGS. 1-27, a lenticular lens plate is used as the lens plate for stereoscopic image display device 700. However, the lens plate for stereoscopic image display device according to the invention is not limited to a lenticular lens plate. For example, the invention can be also applied to a stereoscopic image display device having the so-called “fly eye lens” in which a plurality lenses are provided in horizontal and vertical lattice arrangement.

According to the invention, it is possible to change the distance between the lens plate and the display panel in a stereoscopic image display device. According to the above described embodiments of the invention, when providing a distance changing member enables moving the lens plate or the display panel to at least two positions of a position for a stereoscopic image viewing and to another position for a two-dimensional image viewing, it is possible to switch and perform a stereoscopic image viewing and a two-dimensional image viewing, easily. It is possible to realize a two-dimensional image viewing by adjusting the distance between the lens plate and the display panel, to change the number of pixels visible through the lens plate, without removing the lens plate and with no resolution drop of image in a two-dimensional image viewing. Further, in case of color displaying, the stereoscopic image display device of the invention enables reduction of the chromatic moire which occurs by the effect of the lens, in comparison with a case of realizing a two-dimensional image viewing by displaying approximately the same image in every viewing directions in the arrangement for a stereoscopic image viewing.

The entire disclosure of Japanese Patent Application No. Tokugan 2002-050244 which was filed on Feb. 26, 2002, and Japanese Patent Application No. Tokugan 2002-327995 which was filed on Nov. 12, 2002, including specification, claims, drawings and summary are incorporated herein by reference in its entirety.

What is claimed is:

1. A stereoscopic image display device comprising a display panel for displaying an image with a plurality of pixels and a lens plate with a plurality of lenses, to enable stereoscopic image viewing about an image displayed on the display panel through the lens plate, further comprising:
a distance changing member for changing a distance between the display panel and the lens plate by moving the lens plate.

2. The stereoscopic image display device according to claim 1, wherein the distance changing member enables moving the lens plate to at least two positions of a first position for a stereoscopic image viewing and to a second position for a two-dimensional image viewing.

3. The stereoscopic image display device according to claim 2, wherein the distance changing member comprises a first holding member for holding the lens plate at the first position.

4. The stereoscopic image display device according to claim 2, wherein the distance changing member comprises a second holding member for holding the lens plate at the second position.

5. The stereoscopic image display device according to claim 1, further comprising a guide member for guiding the lens plate to move in a predetermined direction.

6. The stereoscopic image display device according to claim 5, wherein the guide member limits movement of the lens plate in a direction parallel to a displaying surface of the display panel and guides the lens plate to move in a direction perpendicular to a displaying surface of the display panel.

7. The stereoscopic image display device according to claim 5, wherein the guide member guides the lens plate to move and slide in a predetermined direction and guides the lens plate to move in a direction perpendicular to a displaying surface of the display panel.

8. The stereoscopic image display device according to claim 7, wherein the guide member guides the lens plate to move and slide in a direction along a predetermined arrangement direction of the pixels of the display panel.

9. The stereoscopic image display device according to claim 7, wherein the guide member guides the lens plate to move and slide in a rotational direction.

10. The stereoscopic image display device according to claim 1, wherein the distance changing member comprises a member having a inclined surface of a predetermined angle, to change the distance between the display panel and the lens plate by moving the lens plate along the inclined surface.

11. A stereoscopic image display device comprising a display panel for displaying an image with a plurality of pixels and a lens plate with a plurality of lenses, to enable stereoscopic image viewing about an image displayed on the display panel through the lens plate, further comprising:
a distance changing member for changing a distance between the display panel and the lens plate by moving the display panel.

12. The stereoscopic image display device according to claim 11, wherein the distance changing member enables moving the display panel to at least two positions of a first position for a stereoscopic image viewing and to a second position for a two-dimensional image viewing.

13. The stereoscopic image display device according to claim 12, wherein the distance changing member comprises a first holding member for holding the display panel at the first position.

14. The stereoscopic image display device according to claim 12, wherein the distance changing member comprises a second holding member for holding the display panel at the second position.

15. The stereoscopic image display device according to claim 11, further comprising a guide member for guiding the display panel to move in a predetermined direction.

16. The stereoscopic image display device according to claim 15, wherein the guide member limits movement of the display panel in a direction parallel to the lens plate and guides the display panel to move and slide in a direction perpendicular to a flat surface of the lens plate.

17. The stereoscopic image display device according to claim 15, wherein the guide member guides the display panel to move and slide in a predetermined direction and guides the display panel to move in a direction perpendicular to a flat surface of the lens plate.

18. The stereoscopic image display device according to claim 17, wherein the guide member guides the display panel to move and slide in a direction along a predetermined arrangement direction of the pixels of the display panel.

19. The stereoscopic image display device according to claim 11, wherein the distance changing member comprises a member having an inclined surface of a predetermined angle, to change the distance between the display panel and the lens plate by moving the lens plate along the inclined surface.

20. The stereoscopic image display device according to claim 1, further comprising a driving member unit for driving the distance changing member in response to a driving signal input from the outside.

21. The stereoscopic image display device according to claim 11, further comprising a driving member unit for driving the distance changing member in response to a driving signal input from the outside.

22. The stereoscopic image display device according to claim 1, further comprising an output unit for outputting a notification signal to an external device according to an operating state of the distance changing member.

23. The stereoscopic image display device according to claim 11, further comprising an output unit for outputting a notification signal to an external device according to an operating state of the distance changing member.

24. An electronic apparatus comprising:
the stereoscopic image display device as claimed in claim 20;
an image control unit for switching image information between image information for stereoscopic viewing and image information for two-dimensional viewing, to output the image information to the stereoscopic image display device; and
an instruction output unit for outputting a driving signal for driving the driving unit, coupled to switching of output image information by the instruction output unit.

25. An electronic apparatus comprising:
the stereoscopic image display device as claimed in claim 21;
an image control unit for switching image information between image information for stereoscopic viewing and image information for two-dimensional viewing, to output the image information to the stereoscopic image display device; and
an instruction output unit for outputting a driving signal for driving the driving unit, coupled to switching of output image information by the instruction output unit.

26. An electronic apparatus connected to the stereoscopic image display device as claimed in claim 22, further comprising:
an image control unit for switching image information between image information for stereoscopic viewing and image information for two-dimensional viewing according to a notification signal output from the output unit, to output the image information to the stereoscopic image display device.

27. An electronic apparatus connected to the stereoscopic image display device as claimed in claim 23, further comprising:
an image control unit for switching image information between image information for stereoscopic viewing and image information for two-dimensional viewing according to a notification signal output from the output unit, to output the image information to the stereoscopic image display device.

28. An electronic apparatus as claimed in claim 24, wherein the image control unit comprises:
an image changing unit for changing an arrangement construction of image information for pixels which form an image information for a two-dimensional image viewing.

29. An electronic apparatus as claimed in claim 25, wherein the image control unit comprises:
an image changing unit for changing an arrangement construction of image information for pixels which form an image information for a two-dimensional image viewing.

30. An electronic apparatus as claimed in claim 26, wherein the image control unit comprises:
an image changing unit for changing an arrangement construction of image information for pixels which form an image information for a two-dimensional image viewing.

31. An electronic apparatus as claimed in claim 27, wherein the image control unit comprises:
an image changing unit for changing an arrangement construction of image information for pixels which form an image information for a two-dimensional image viewing.
